(19) United States
(12) Patent Application Publication
(10) Pub. No.: US 2012/0307136 A1
(43) Pub. Date: Dec. 6, 2012

(54) IMAGING APPARATUS, LIGHT AMOUNT MEASUREMENT APPARATUS, RECORDING MEDIUM AND METHOD OF CALCULATING EXPOSURE AMOUNT

(75) Inventor: Yasutoshi Katsuda, Kanagawa (JP)

(73) Assignee: Sony Corporation, Tokyo (JP)

(21) Appl. No.: 13/445,561

(22) Filed: Apr. 12, 2012

(30) Foreign Application Priority Data
May 31, 2011 (JP) 2011-121869

(51) Int. Cl. H04N 5/238; H04N 5/235

(52) U.S. Cl. 348/366; 348/E05.034; 348/E05.04

(57) ABSTRACT

An imaging apparatus includes a light beam division element for dividing an incident light beam into first and second light beams, a light reception unit on which the first beam is incident, for acquiring an intensity of a P or S-polarized component for the first beam, an irradiated body on which the second beam is incident, a signal processing unit for outputting a predicted value of an intensity of a P or S-polarized component for the second beam from the intensity of the P or S component acquired by the light reception unit, a shutter for switching incidence and blocking of the second beam on and to the body, and an iris for adjusting an amount of the second beam reaching the body. At least one of a speed of the shutter or an opening of the iris is adjusted according to an output from the processing unit.

### BACKGROUND

The present disclosure relates to an imaging apparatus, a light amount measurement apparatus, a recording medium, and a method of calculating an exposure amount. In particular, the present disclosure relates to an imaging apparatus using a part of incident light to calculate an exposure amount, a light amount measurement apparatus, a recording medium, and a method of calculating an exposure amount.

When photographing is performed in an outdoor area where sunlight is strong using an imaging apparatus, such as a camera or when a subject containing a large percentage of a white part is photographed using the imaging apparatus, so-called over-exposure may be caused in an obtained picture. The over-exposure occurs when an amount of exposure to photographic film or an imaging element becomes excessively great. Conversely, when photographing is performed in a dark place or when a subject containing a large percentage of a black part is photographed, so-called under-exposure may be caused in an obtained picture. In order to prevent the occurrence of the over-exposure or the under-exposure, it is necessary to adjust the amount of the exposure to the photographic film or the imaging element according to a photographing situation.

In recent years, most cameras have an automatic exposure function or an automatic distance measurement function (an autofocus function). In the camera having the automatic exposure function, the camera performs adjustment of the exposure amount to obtain appropriate exposure.

However, for example, when light from a subject is polarized, the camera having an automatic exposure function may calculate the wrong exposure amount. In particular, in a camera using a metering result for light from a subject reflected by (or transmitted through) an optical element, such as a half mirror, to calculate the exposure amount, if the light from the subject is polarized, it is easy for the camera to calculate the wrong exposure amount. This is because the half mirror exhibits different reflection characteristics (or transmission characteristics) for a P-polarized component and an S-polarized component of the incident light.

If the camera calculates the wrong exposure amount, an obtained picture becomes different from an image expected by a photographer. For example, when the light from the subject is light reflected by a water surface or a glass surface, it is difficult for the camera to correctly perform the adjustment of the exposure amount, and over-exposure or under-exposure that is not intended by the photographer is caused. The same occurs when the light from the subject is light from a liquid crystal display device.

When appropriate exposure is not obtained by the automatic exposure function, it is necessary for the photographer to further correct the exposure amount by using an optical filter or adjusting an iris or a shutter speed. However, the correction of the exposure amount needs experience or skill and the photographer may not often faithfully photograph a subject. Further, if the subject moves, the photographer may miss a precious shutter chance when adjusting the iris or the shutter speed.

Various proposals for preventing the camera from calculating the wrong exposure amount even when the light from the subject is polarized have been made. For example, arranging a half-prism in an optical system and making a ratio of a P component and an S component of light transmitted through the half-prism substantially equal to a ratio of a P component and an S component of light transmitted through the half mirror after reflected by the half-prism is proposed in Japanese Patent Laid-Open No. 63-231415. Furthermore, in order to resolve discrepancy between the photographer's vision and the obtained picture, for example, arranging a non-polarization beam splitter on an optical path of an observing optical system of an imaging apparatus to reduce uneven brightness of the observing optical system has been proposed in Japanese Patent Laid-Open No. 2006-349960.

However, in a technique disclosed in Japanese Patent Laid-Open No. 63-231415, a complex optical part is necessary and an imaging apparatus becomes large and heavy. In a technique disclosed in Japanese Patent Laid-Open No. 2006-349960, a special optical part is necessary and there are many limitations on the design.

### SUMMARY

In an imaging apparatus, a light amount measurement apparatus, and the like, it is preferable for adjustment of an exposure amount to be correctly performed even when light from a subject is polarized.

According to a first preferred embodiment of the present disclosure, an imaging apparatus includes a light beam division element, a light reception unit, an irradiated body, a signal processing unit, a shutter, and an iris.

The light beam division element divides an incident light beam into a first light beam and a second light beam.

The first light beam is incident on the light reception unit, which acquires an intensity of a P-polarized component or an intensity of an S-polarized component for the first light beam.

The second light beam is incident on the irradiated body.

The signal processing unit outputs a predicted calculation value of an intensity of a P-polarized component or a predicted calculation value of an intensity of an S-polarized component for the second light beam, from the intensity of the P-polarized component or the intensity of the S-polarized component acquired by the light reception unit.

The shutter switches incidence and blocking of the second light beam on and to the irradiated body.

The iris adjusts an amount of the second light beam reaching the irradiated body.

At least one of a shutter speed of the shutter or an opening of the iris is adjusted according to an output from the signal processing unit.

According to a second preferred embodiment of the present disclosure, a light amount measurement apparatus includes a light beam division element, a light reception unit, and a signal processing unit.

The light beam division element divides an incident light beam into a first light beam and a second light beam.

One of the first light beam or the second light beam is incident on the light reception unit, which acquires an intensity of a P-polarized component or an intensity of an S-polarized component for the one light beam.

The signal processing unit outputs a predicted calculation value of an intensity of a P-polarized component or a predicted calculation value of an intensity of an S-polarized component for the other of the first light beam and the second light beam, from the intensity of the P-polarized component or the intensity of the S-polarized component acquired by the light reception unit.

According to a third preferred embodiment of the present disclosure, a recording medium is a computer-readable recording medium.

A program is recorded on the computer-readable recording medium.

The recorded program is a program causing a computer to execute: receiving an intensity of a P-polarized component or an intensity of an S-polarized component for a part of one incident light beam divided from the one incident light beam by a light beam division element, and outputting a predicted calculation value of an intensity of a P-polarized component or a predicted calculation value of an intensity of an S-polarized component for a residual light beam of the one incident light beam from data of reflectance or transmittance of the light beam division element corresponding to the P-polarized component or the S-polarized component.

According to a fourth preferred embodiment of the present disclosure, a method of calculating an exposure amount includes: acquiring, by a first light reception unit, an intensity of a P-polarized component or an intensity of an S-polarized component for a first light beam divided from one incident light beam by a light beam division element; and predicting, by a signal processing unit, an intensity of a P-polarized component or an intensity of an S-polarized component for a second light beam divided from the one incident light beam by the light beam division element, from the intensity of the P-polarized component or the intensity of the S-polarized component acquired by the first light reception unit, to calculate an exposure amount in a second light reception unit on which the second light beam is incident.

Here, the “P-polarized component” in the present disclosure refers to a polarized component oscillating within an incident plane, which is a surface including a normal vector of a surface of the light beam division element and an electric field vector of incident light. Further, the “S-polarized component” in the present disclosure refers to a polarized component oscillating perpendicular to the incident plane of the light beam division element. The same also applies to light reflected by the light beam division element and light transmitted through the light beam division element.

Further, “reflectance” in the present disclosure refers to energy reflectance, and “transmittance” in the present disclosure refers to energy transmittance. That is, if the “reflectance” is Γ and the “transmittance” is Π, a relationship of Γ+Π=1 is satisfied. Further, it is assumed that the “reflectance” and the “transmittance” in the present disclosure refer to average reflectance and average transmittance in a wavelength region of 400 nm to 750 nm, respectively, unless mentioned otherwise.

In the present disclosure, the incident light beam is divided into, for example, two light beams by the light beam division element. One (the first light beam) of the divided light beams is incident, for example, on the light reception unit. In the present disclosure, the light reception unit acquires the intensity of the P-polarized component or the intensity of the S-polarized component for the light beam incident on the light reception unit. Accordingly, the intensity of the P-polarized component and the intensity of the S-polarized component for the light beam incident on the light reception unit are individually acquired.

The light beam division element is, for example, an optical element for reflecting a part of light from the subject and transmitting residual light. Generally, reflectance for the P-polarized component in the light beam division element differs from reflectance for the S-polarized component. That is, a ratio between the P-polarized component and the S-polarized component in the first light beam depends on a reflection characteristic of the light beam division element. Similarly, a ratio between the P-polarized component and the S-polarized component in the other light beam (the second light beam) divided by the light beam division element also depends on the reflection characteristic (the transmission characteristic) of the light beam division element. Accordingly, if an intensity for the one of the light beams divided by the light beam division element is predicted based on intensities of all oscillating components for the other light beam, there is a great difference between a predicted intensity and an actual intensity according to a polarization degree of the incident light beam.

In other words, this means that, if an intensity of a P-polarized component and an intensity of an S-polarized component for one of the light beams divided by the light beam division element is obtained, an intensity of a P-polarized component and an intensity of an S-polarized component for the other light beam can be predicted. For example, if the reflection characteristic (the transmission characteristic) of the light beam division element has been recognized for each polarized component in advance, the intensity of the P-polarized component for the one light beam of the light beams divided by the light beam division element is accurately predicted from the intensity of the P-polarized component for the other light beam. Similarly, the intensity of the S-polarized component for the one light beam is accurately predicted from the intensity of the S-polarized component for the other light beam. Accordingly, based on the intensity of the P-polarized component or the intensity of the S-polarized component for the one light beam, the intensity for the other light beam is predicted as a sum of the intensity of the P-polarized component and the intensity of the S-polarized component for the other light beam.

In the present disclosure, the intensity of the P-polarized component or the intensity of the S-polarized component for the light beam incident on the light reception unit is acquired, as described above. That is, the intensity of the P-polarized component and the intensity of the S-polarized component for the light beam incident on the light reception unit are individually acquired. Accordingly, the intensity of the P-polarized component and the intensity of the S-polarized component for the other light beam are accurately predicted, unlike a case in which an intensity of one light beam among light beams divided by the light beam division element is acquired without distinction between the P-polarized component and the S-polarized component. Accordingly, even when a polarization degree of the incident light beam is great, there is no great discrepancy between a predicted intensity and an actual intensity.

According to at least an example, it is possible to provide an imaging apparatus, a light amount measurement apparatus, a recording medium, and a method of calculating an exposure amount, in which adjustment of an exposure amount is correctly performed even when incident light is polarized.

### BRIEF DESCRIPTION OF THE DRAWINGS

FIG. 1 is a schematic diagram showing a schematic configuration of an imaging apparatus according to a first embodiment;

FIG. 2 is a block diagram showing a configuration example of the imaging apparatus according to the first embodiment;

FIGS. 3A and 3B are schematic perspective views showing an example of a polarization element for switching a P-polarized component or an S-polarized component of light reaching a light receiving element;

FIGS. 4A and 4B are schematic perspective views showing another example of the polarization element for switching a P-polarized component or an S-polarized component of light reaching a light receiving element;

FIGS. 5A to 5D are views illustrating a liquid crystal element constituting the polarization element;

FIGS. 6A and 6B are views showing an example in which the polarization element includes a plurality of liquid crystal elements like the one in FIGS. 5A to 5D;

FIGS. 7A and 7B are views showing an example in which the polarization element includes a plurality of liquid crystal elements like the one in FIGS. 5A to 5D;

FIG. 8A is a graph showing an example of a reflection characteristic and a transmission characteristic of a light beam division element, and FIG. 8B is a graph showing another example of the reflection characteristic and the transmission characteristic of the light beam division element;

FIG. 9 is a schematic diagram showing a schematic configuration of a variant of the imaging apparatus according to the first embodiment;

FIGS. 10A and 10B are schematic diagrams showing a schematic configuration of an imaging apparatus according to a second embodiment;

FIGS. 11A and 11B are schematic diagrams showing a schematic configuration of a variant of the imaging apparatus according to the second embodiment; and

FIG. 12 is a block diagram showing a configuration example of a light amount measurement apparatus according to a third embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments of an imaging apparatus, a light amount measurement apparatus, a recording medium, and a method of calculating an exposure amount will be described. A description thereof will be given in the following order:
<1. First Embodiment>

[Schematic Configuration of Imaging Apparatus]

[Operation of Imaging Apparatus]

[Application Example of Automatic Exposure]

[Variant of First Embodiment]
<2. Second Embodiment>

[Schematic Configuration of Imaging Apparatus]

[Operation of Imaging Apparatus]

[Variant of Second Embodiment]
<3. Third Embodiment>

[Schematic Configuration of Light Amount Measurement Apparatus]
<4. Variant>

Embodiments to be described hereinafter are preferred concrete examples of the imaging apparatus, the light amount measurement apparatus, the recording medium, and the method of calculating an exposure amount. In the following description, various limitations that are technically preferred are applied, but examples of the imaging apparatus, the light amount measurement apparatus, the recording medium, and the method of calculating an exposure amount are not limited to the following embodiments unless mentioned otherwise.

### 1. First Embodiment

### [Schematic Configuration of Imaging Apparatus]

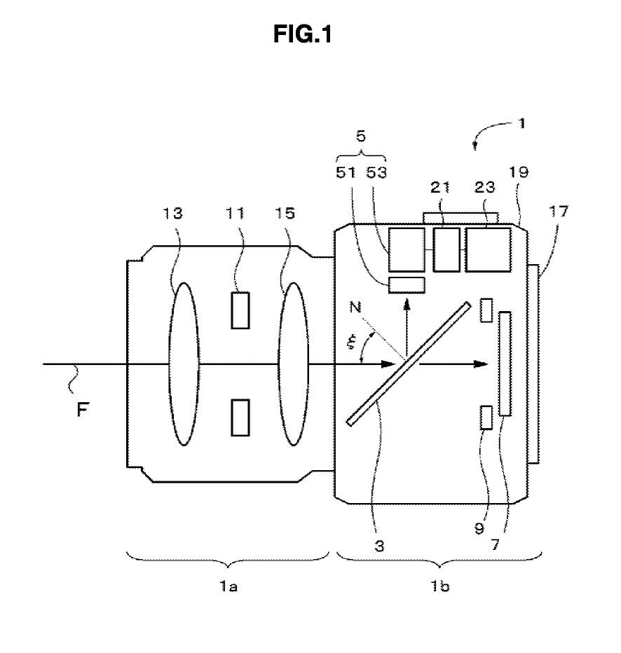

FIG. 1 is a schematic diagram showing a schematic configuration of an imaging apparatus according to a first embodiment. As shown in FIG. 1, the imaging apparatus 1 according to the first embodiment includes a light beam division element 3, a light reception unit 5, an irradiated body 7, a signal processing unit 21, a shutter 9, and an iris 11. Specifically, the imaging apparatus 1 according to the first embodiment is, for example, a camera with a pellicle mirror. In the example shown in FIG. 1, a lens-barrel 1a is detachably mounted on a housing 19 of a main body 1b of the imaging apparatus 1. It is understood that the lens-barrel 1a and the main body 1b may be integrally formed to constitute the imaging apparatus 1. The iris 11 and lenses 13 and 15 are arranged inside the lens-barrel 1a. The lenses 13 and 15 are driven by a focus drive system for an autofocus operation, but the focus drive system is not shown in FIG. 1.

The light beam division element 3 reflects a part of a light beam F incident on the imaging apparatus 1 and transmits a residual light beam to divide the incident light beam F into, for example, two light beams. The one light beam divided by the light beam division element 3 is incident on the light reception unit 5. The light reception unit 5 acquires an intensity of a P-polarized component or an intensity of an S-polarized component for the incident light beam. The intensity of the P-polarized component or the intensity of the S-polarized component acquired by the light reception unit 5 is input to the signal processing unit 21. The other light beam divided by the light beam division element 3 is incident on the irradiated body 7. Incidence and blocking of the light beam on and to the irradiated body 7 are switched by the shutter 9, and an amount of the light beam reaching the irradiated body 7 is adjusted by the iris 11. At least one of a shutter speed of the shutter 9 or an opening of the iris 11 is adjusted according to an output from the signal processing unit 21. Adjustment of the shutter speed of the shutter 9 or the opening of the iris 11 is executed according to a predicted calculation value of the intensity of the P-polarized component or a predicted calculation value of the intensity of the S-polarized component for the light beam incident on the irradiated body 7, which is output by the signal processing unit 21.

Hereinafter, the light beam division element 3, the light reception unit 5, the irradiated body 7, the signal processing unit 21, the shutter 9 and the iris 11 will be described in this order with reference to FIG. 1.

(Light Beam Division Element)

The light beam division element 3 is an optical element for reflecting and transmitting light from the subject incident into the housing 19 via the iris 11 and the lenses 13 and 15. The light beam division element 3 reflects a part of the light from the subject and transmits residual light. Reflectance of the light beam division element 3 is, for example, about 30% and accordingly, transmittance of the light beam division element 3 is, for example, about 70%. It is understood that the reflectance and the transmittance of the light beam division element 3 for the light from the subject are not limited to the above values and may be appropriately set.

In the first embodiment, the light beam division element 3 is fixed to the using 19 inside the imaging element 1. That is, in the first embodiment, an angle ξ between a normal N to a reflection surface of the light beam division element 3 and an optical axis of the incident light beam F is constant. From the viewpoint of reducing degradation of picture quality, it is preferable for the angle ξ be smaller than 45°. This is because a distance across which the light from the subject passes through the light beam division element 3 (which may be called an optical distance) can be smaller, as compared to when the angle ξ is equal to or more than 45°.

For example, a translucent mirror may be used as the light beam division element 3. The translucent mirror, for example, may be formed by forming an optical thin film on a main surface of a light-transmitting base material. A material constituting the light-transmitting base material includes, for example, a resin material or glass. When the resin film is used as the light-transmitting base material, the imaging apparatus 1 may be miniaturized and lightweight. While a prismatic or a wedge substrate type of optical element may be used instead of the translucent mirror as the light beam division element 3, it is preferable for a flat optical element to be selected from the viewpoint of reducing degradation of picture quality. This is because the distance across which the light from the subject passes through the light beam division element 3 can be smaller as compared to when the optical element is of a prismatic or a wedge substrate type. It is preferable for the light-transmitting base material to have a thickness of 10 μm to 100 μm.

(Light Reception Unit)

The light reception unit 5 is an optical part to which the one light beam among the light beams divided by the light beam division element 3 is incident.

The light reception unit 5, specifically, is a so-called metering sensor. The light reception unit 5, for example, is arranged inside the housing 19 so that the part of the light from the subject reflected by the light beam division element 3 is incident on the light reception unit 5.

The light reception unit 5 may acquire the intensity of the P-polarized component or the intensity of the S-polarized component for the light beam incident on the light reception unit 5. The light reception unit 5, for example, includes a polarization element 51 and one or more light receiving elements 53. As will be described later, in the present disclosure, the light reception unit 5 acquires the intensity of the P-polarized component or the intensity of the S-polarized component for the incident light beam. The light reception unit 5 may include a distance measuring sensor for an autofocus function.

For example, a silicon photodiode, a gallium arsenide photodiode, an image sensor such as a CCD (Charge Coupled Device) or a CMOS (Complementary Metal Oxide Semiconductor), a cadmium sulfide cell (CdS cell) including a sintered body of cadmium sulfide, or the like may be used as the light receiving element 53. A concrete configuration example of the polarization element 51 will be described later.

(Irradiated Body)

The light beam not incident on the light reception unit 5 among the light beams divided by the light beam division element 3 is incident on the irradiated body 7. That is, for example, when the part of the light from the subject reflected by the light beam division element 3 is incident on the light reception unit 5, the irradiated body 7 is arranged inside the housing 19 so that the light from the subject not reflected by the light beam division element 3 but transmitted through light beam division element 3 is incident on the irradiated body 7.

Specifically, the irradiated body 7 is, for example, photographic film or an imaging element. As the imaging element, for example, an image sensor such as a CCD or a CMOS may be used. While the following description will be given on the assumption that the irradiated body 7 is the imaging element, the imaging apparatus of the present disclosure may be either an analog camera using photographic film or a digital camera using the imaging element.

A display unit 17 functioning as an electronic view finder is provided in the imaging apparatus 1, as necessary. The display unit 17, for example, is a flat display, such as a liquid crystal display (LCD) or an organic EL (Electroluminescence) display. While the display unit 17 is provided at a rear side of the housing 19 in the example shown in FIG. 1, a position in which the display unit 17 is provided is not limited thereto. The display unit 17 may be provided, for example, in a top surface of the housing 19. The display unit 17 may be movable or detachable. The display unit 17 may be provided inside the finder. It is understood that the display unit 17 may be, for example, an input device, such as a touch panel, that receives an instruction from a user.

A signal from the imaging element is subjected to picture processing such as digital gain adjustment, gamma correction, color correction, or contrast correction by the signal processing unit 21, which will be described later, and supplied as a picture signal to the display unit 17. Accordingly, a current subject image is displayed on the display unit 17.

(Signal Processing Unit)

The signal processing unit 21 is a processing device receiving an output signal from the light reception unit 5 or the irradiated body 7 or a command signal from a user of the imaging apparatus 1 and performing various arithmetic processing and control of each unit of the imaging apparatus 1. The signal processing unit 21 includes, for example, an analog/digital conversion circuit, a picture processing circuit, a compression and decompression circuit, a video signal output circuit, an input/output circuit and the like, in addition to a microprocessor. A program for performing the various arithmetic processing and the control of each unit of the imaging apparatus 1, for example, is stored in a storage unit 23 connected to the signal processing unit 21, as will be described later. The signal processing unit 21 may be a processing device including the storage unit 23.

In the present disclosure, the predicted calculation value of the intensity of the P-polarized component or the predicted calculation value of the intensity of the S-polarized component for the light beam incident on the irradiated body 7 is calculated from the intensity of the P-polarized component or the intensity of the S-polarized component acquired by the light reception unit 5, by the signal processing unit 21. Accordingly, a program for causing the signal processing unit 21 to output a predicted calculation value of the intensity of the P-polarized component or a predicted calculation value of the intensity of the S-polarized component for the light beam incident on the irradiated body 7, from the intensity of the P-polarized component or the intensity of the S-polarized component acquired by the light reception unit 5 is stored in the storage unit 23.

Examples of the storage unit 23 include a non-volatile or volatile memory, and a recording medium, such as an optical recording medium, a magneto-optical recording medium or a magnetic recording medium. The stored program may be read by a computer, and a type of recording medium is not particularly limited.

(Shutter)

The shutter 9, for example, is arranged inside the imaging apparatus 1 in order to switch incidence and blocking of the light, which has been transmitted through the light beam division element 3, on and to the irradiated body 7. The shutter 9 may include a focal plane shutter arranged directly before a light receiving surface of the irradiated body 7, a lens shutter arranged inside the lens-barrel 1a, or the like. Further, a mechanical shutter with a mechanical operation, an electronic shutter for acquiring an output signal from the imaging element by time according to a shutter speed, or a combination thereof may be used as the shutter 9. Specifically, when the shutter 9 is the mechanical shutter, for example, an interval between slits provided in the shutter 9 is freely changed and the shutter speed of the shutter 9 is adjusted by changing the interval between the slits.

While the imaging apparatus including the focal plane shutter as the shutter 9 has been illustrated in FIG. 1, a type of shutter 9 is not limited thereto and may be appropriately selected. Further, while the shutter 9 is explicitly shown in FIG. 1, the imaging element as the irradiated body 7 functions as the shutter 9 when an electronic shutter is used, and accordingly, the shutter 9 as a member need not be necessarily arranged inside the imaging apparatus 1.

(Iris)

The iris 11 is arranged inside the imaging apparatus 1 in order to adjust an amount of the light beam incident on the irradiated body 7. The iris 11 generally is a combination of a plurality of wing-shaped light shielding members. The iris 11, for example, is arranged inside the lens-barrel 1a. It is understood that the iris 11 may be arranged inside the main body 1b. Opening of the iris 11 is adjusted by changing overlap of the plurality of light shielding members.

### [Operation of Imaging Apparatus]

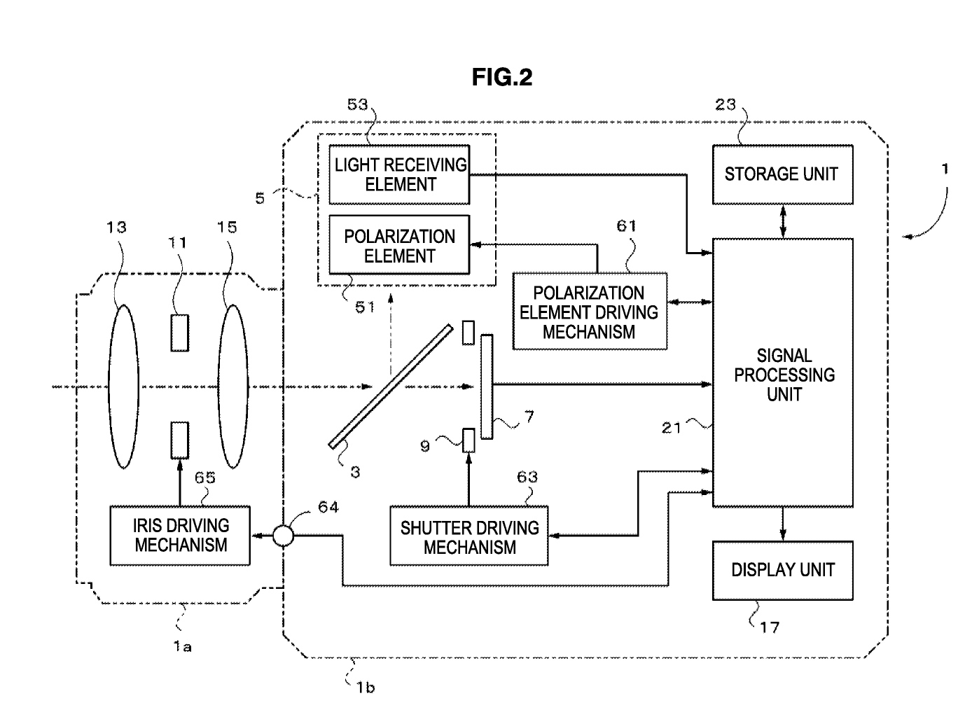

Next, operation of the imaging apparatus according to the first embodiment will be described with reference to FIG. 2.

FIG. 2 is a block diagram showing a configuration example of the imaging apparatus according to the first embodiment. A distance measuring sensor for an autofocus function, an infrared cut filter, a main body memory or an external memory in which picture data is stored, a control circuit for various driving mechanisms, a driving circuit of a display unit, and the like are not shown in FIG. 2. Even in the following description, they are not shown unless mentioned otherwise.

First, the light from the subject is incident on the light beam division element 3 via the lenses 13 and 15 and the iris 11. In this case, the iris 11 is fully open. A part of light incident on the light beam division element 3 is reflected by the light beam division element 3 and incident on the light reception unit 5. Meanwhile, light transmitted through the light beam division element 3 proceeds toward the shutter 9 and the irradiated body 7.

The light reception unit 5 receives the light reflected by the light beam division element 3 and acquires information on an energy amount of the light reaching the light reception unit 5, for example, through a photoelectric conversion operation of a light receiving element. The light reception unit 5 transmits the acquired information as an output signal to the signal processing unit 21. The signal processing unit 21 receives the output signal from the light reception unit 5 and performs arithmetic processing to calculate an exposure amount. That is, the amount of exposure to the irradiated body 7 is calculated based on an energy amount carried by the light reflected by the light beam division element 3 in an energy amount carried by the light from the subject.

### (Acquisition of Information on Energy Amount of P-Polarized Component or S-Polarized Component)

Here, in the present disclosure, when information on the energy amount of the light reaching the light reception unit 5 is acquired, acquisition of information on the energy amount of the P-polarized component or the S-polarized component of the light reaching the light reception unit 5 is performed. The acquisition of the information is continuously performed, for example, when the light reflected by the light beam division element 3 is incident on the light reception unit 5 (metering at all times). Alternatively, for example, the acquisition of the information is performed when a photographer has half-pressed a shutter button. In the acquisition of the information, it is preferable for the iris 11 to be fully opened so that as much light reaches the light reception unit 5 as possible. The acquisition of the information on the energy amount of the P-polarized component or the S-polarized component of the light reaching the light reception unit 5 is realized, for example, by switching a polarized component transmitted through the polarization element 51 arranged between the light beam division element 3 and the light receiving element 53.

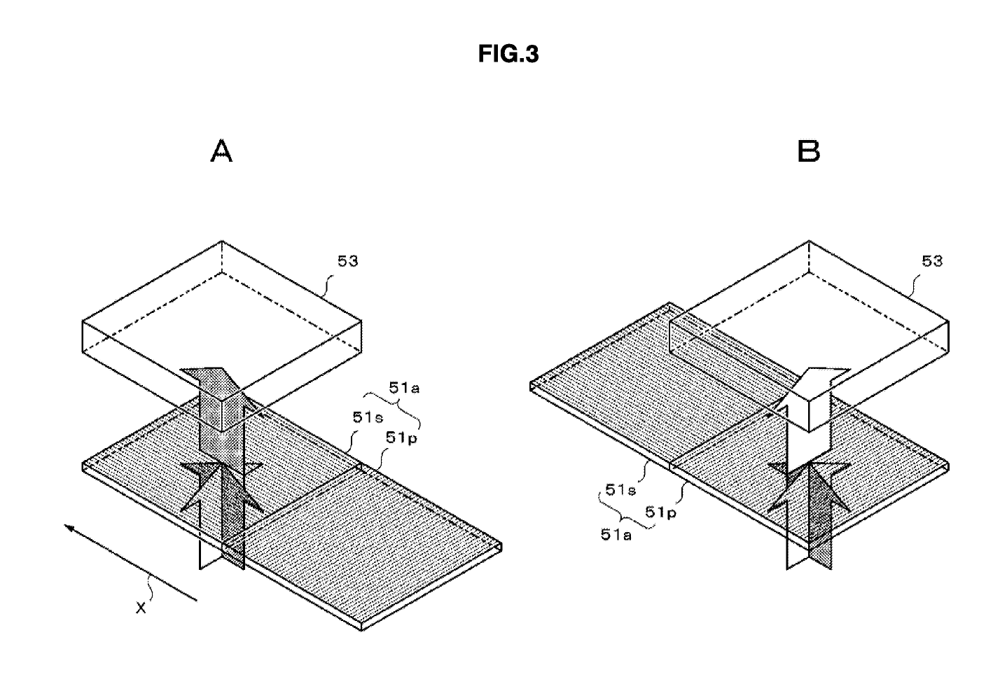

FIGS. 3A and 3B are schematic perspective views showing an example of a polarization element for switching the P-polarized component or the S-polarized component of the light reaching the light receiving element. The polarization element for switching the P-polarized component or the S-polarized component of the light reaching the light receiving element 53 includes, for example, one or more polarizers. For example, a polarization element 51a shown in FIGS. 3A and 3B includes two polarizers 51s and 51p arranged side by side in the same plane. The polarizer 51s transmits only the S-polarized component among the polarized components of the light reflected by the light beam division element 3. On the other hand, the polarizer 51p transmits only the P-polarized component among the polarized components of the light reflected by the light beam division element 3. One of the polarizer 51s or the polarizer 51p is arranged in a direction parallel to an absorption axis of the other polarizer.

FIG. 3A is a diagram showing an arrangement of the polarization element 51 and the light receiving element 53 when acquisition of information on the energy amount of the S-polarized component among the polarized components of the light reflected by the light beam division element 3 is performed. As shown in FIG. 3A, when the information on the energy amount of the S-polarized component is acquired, the polarizer 51s is arranged between the light beam division element 3 and the light receiving element 53. Since the polarizer 51s transmits only the S-polarized component among the polarized components of the light reflected by the light beam division element 3, only the S-polarized component among the polarized components of the light reflected by the light beam division element 3 reaches the light receiving element 53. Accordingly, the light reception unit 5 acquires information on the energy amount of the S-polarized component among the polarized components of the light reflected by the light beam division element 3. Further, in FIG. 3A, a shaded arrow schematically indicates the S-polarized component among the polarized components of the light reflected by the light beam division element 3, and a non-shaded arrow schematically indicates the P-polarized component. The same also applies to the following description.

FIG. 3B is a diagram showing an arrangement of the polarization element 51 and the light receiving element 53 when acquisition of the information on the energy amount of the P-polarized component among the polarized components of the light reflected by the light beam division element 3 is performed. When the information on the energy amount of the P-polarized component is acquired, the polarizer 51s and the polarizer 51p move, for example, in a direction along an absorption axis of the polarizer 51p (a direction indicated by an arrow X shown in FIG. 3A). Accordingly, when the information on the energy amount of the P-polarized component is acquired, the polarizer 51p is arranged between the light beam division element 3 and the light receiving element 53, as shown in FIG. 3B. Thus, the light reception unit 5 can acquire the information on the energy amount of the P-polarized component or the S-polarized component of the light reaching the light reception unit 5.

Further, the polarization element may be configured of either the polarizer 51s or the polarizer 51p instead of being configured of the polarizer 51s and the polarizer 51p arranged side by side. For example, when the polarization element is configured of only the polarizer 51s without the polarizer 51p, for example, acquisition of information on the energy amount of the S-polarized component among the polarized components of the light reflected by the light beam division element 3 is first performed. Thereafter, the polarizer 51s is evacuated from an optical path, and then if acquisition of information on an energy amount of the light reflected by the light beam division element 3 is performed, information on a sum of the energy amount of the S-polarized component and the energy amount of the P-polarized component of the light reflected by the light beam division element 3 (a total energy amount of the light reflected by the light beam division element 3) is acquired. In this case, the energy amount of the P-polarized component may be calculated as a difference between the latter and the former.

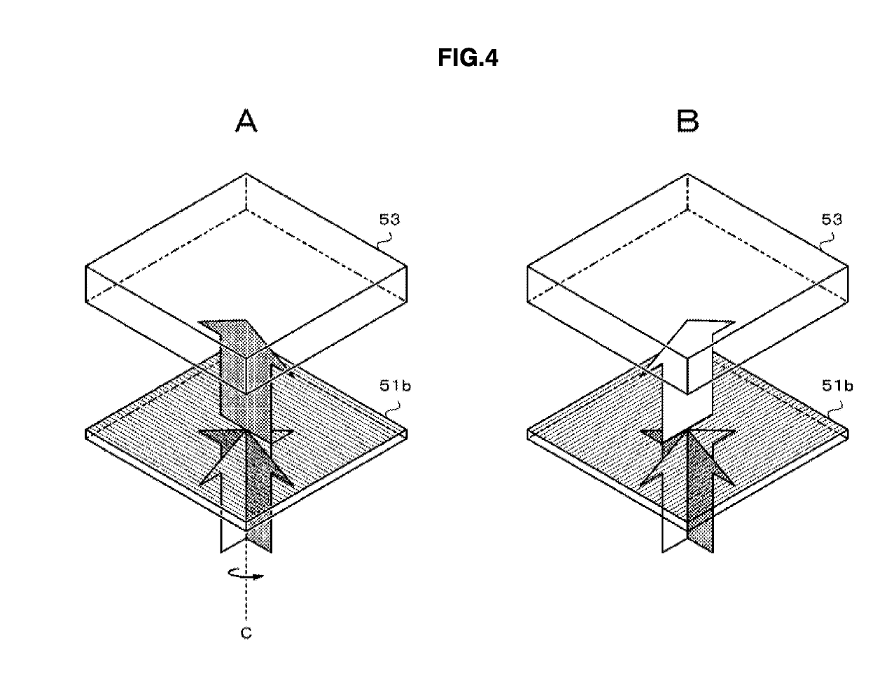

FIGS. 4A and 4B are schematic perspective views showing another example of the polarization element for switching the P-polarized component or the S-polarized component of the light reaching the light receiving element. In the example shown in FIGS. 4A and 4B, a polarization element 5 1b includes one polarizer for linearly polarizing transmitted light.

FIG. 4A is a view showing an arrangement of the polarization element 51b and the light receiving element 53 when acquisition of information on the energy amount of the S-polarized component among the polarized components of the light reflected by the light beam division element 3 is performed. As shown in FIG. 4A, the polarizer 51b is arranged between the light beam division element 3 and the light receiving element 53.

In an initial state, the polarizer 51b, for example, transmits only the S-polarized component among the polarized components of the light reflected by the light beam division element 3. Accordingly, the light reception unit 5 acquires information on the energy amount of the S-polarized component among the polarized components of the light reflected by the light beam division element 3.

When the information on the energy amount of the P-polarized component is acquired, the polarizer 51b is rotated 90° around an axis parallel to a direction along an optical axis of the light reflected by the light beam division element 3 (an axis C shown in FIG. 4A), which is a rotation axis. By doing so, an absorption axis of the polarizer 51b is rotated 90° and the polarizer 51b transmits only the P-polarized component among the polarized components of the light reflected by the light beam division element 3. Accordingly, the light reception unit 5 can acquire information on the energy amounts of the P- and S-polarized components of the light reaching the light reception unit 5.

The polarization element 51 may include a liquid crystal element rather than the polarizer.

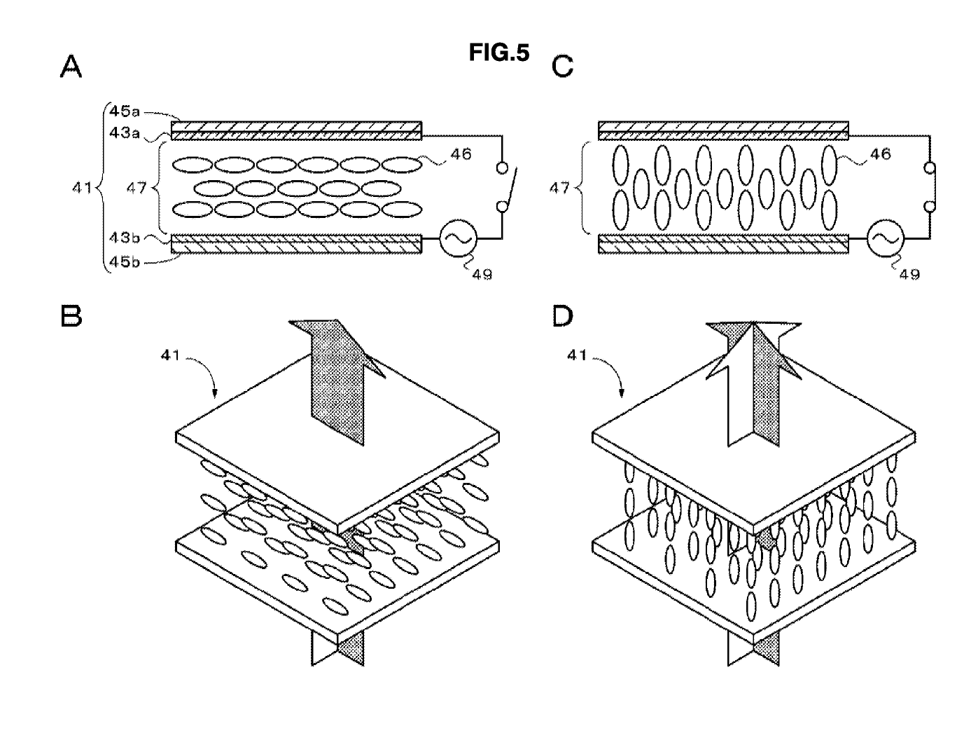

FIGS. 5A to 5D are diagrams illustrating a liquid crystal element constituting the polarization element. FIG. 5A is a schematic sectional view of the liquid crystal element constituting the polarization element 41. As shown in FIG. 5A, the liquid crystal element 41 includes, for example, light-transmitting base materials 45a and 45b, transparent conductive layers 43a and 43b, and a liquid crystal layer 47 including liquid crystal molecules 46. The transparent conductive layer 43a and the transparent conductive layer 43b are provided on one surface of the light-transmitting base material 45a and one surface of the light-transmitting base material 45b, respectively, and the light-transmitting base material 45a and the light-transmitting base material 45b are arranged so that the transparent conductive layer 43a and the transparent conductive layer 43b face each other. The liquid crystal layer 47 is sealed between the light-transmitting base material 45a having the transparent conductive layer 43a provided thereon and the light-transmitting base material 45b having the transparent conductive layer 43b provided thereon. The transparent conductive layer 43a and the transparent conductive layer 43b are connected to a power supply 49 so that an electric field is generated between the transparent conductive layer 43a and the transparent conductive layer 43b.

As shown in FIGS. 5A and 5B, the transparent conductive layer 43a and the transparent conductive layer 43b are not connected to the power supply 49 in an initial state, and long axis directions of the liquid crystal molecules 46 in the liquid crystal layer 47 are aligned in a direction parallel to surfaces of the transparent conductive layer 43a and the transparent conductive layer 43b. When light is incident on the liquid crystal element 41 in the state shown in FIG. 5A, the liquid crystal element 41 transmits only a component oscillating along the long axis direction of the liquid crystal molecules 46 among polarized components of the incident light. For example, as shown in FIG. 5B, the liquid crystal element 41 transmits only the S-polarized component among the polarized components of the incident light. Accordingly, the liquid crystal element 41 in which the transparent conductive layer 43a and the transparent conductive layer 43b are not connected to the power supply 49 has the same function as the polarizer. In FIG. 5B, the power supply 49 is not shown.

FIGS. 5C and 5D are diagrams showing a state in which the electric field is generated between the transparent conductive layer 43a and the transparent conductive layer 43b as the power supply 49 is connected to the transparent conductive layer 43a and the transparent conductive layer 43b. An arrangement of the liquid crystal molecules 46 in the liquid crystal layer 47 is simply changed due to stimulation such as application of the electric field. If the electric field is applied to the liquid crystal molecules 46 in the liquid crystal layer 47, the arrangement of the liquid crystal molecules 46 is changed so that the long axis directions of the liquid crystal molecules 46 are parallel to the electric field. If the arrangement of the liquid crystal molecules 46 is changed so that the long axis directions of the liquid crystal molecules 46 are parallel to the electric field, the P-polarized component and the S-polarized component of the incident light pass through the liquid crystal element 41 together, as shown in FIG. 5D. The power supply 49 is not shown in FIG. 5D.

As described above, the liquid crystal element 41 can switch the polarized component transmitted through the liquid crystal element 41 according to whether the transparent conductive layer 43a and the transparent conductive layer 43b are electrically conducted or not. Further, the polarization element for selectively switching a polarized component to be transmitted may be a combination of a plurality of liquid crystal elements like the one in FIGS. 5A to 5D.

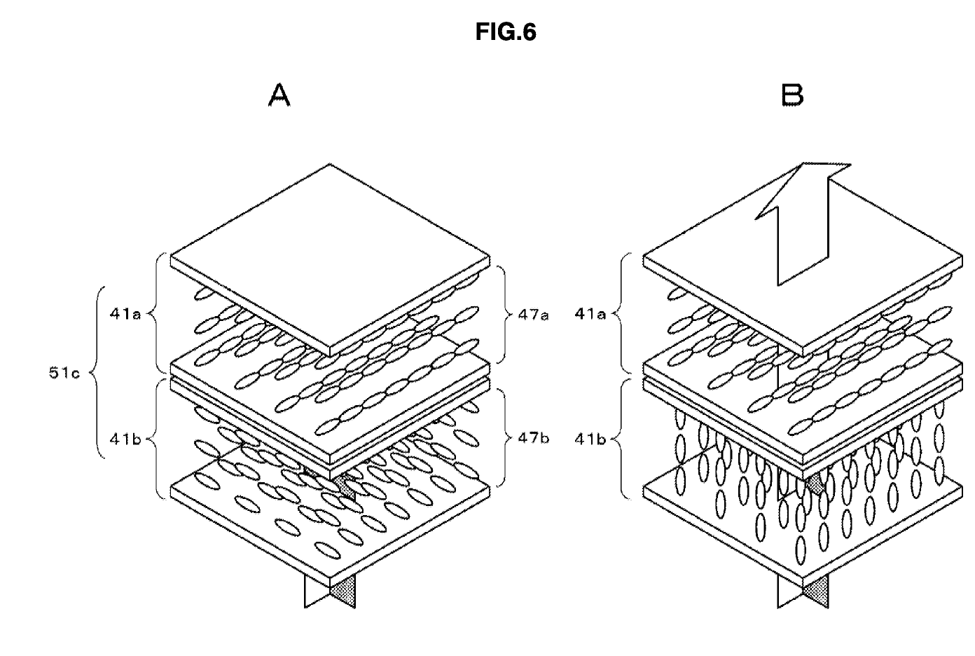

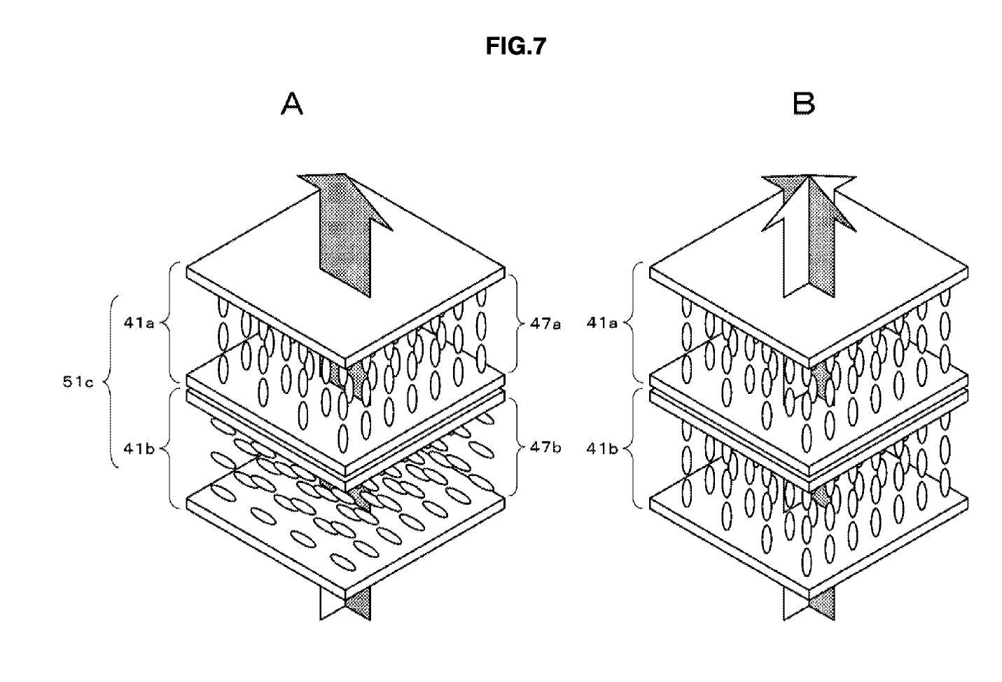

FIGS. 6A and 6B and FIGS. 7A and 7B are diagrams showing an example in which the polarization element includes a plurality of liquid crystal elements like the one in FIGS. 5A to 5D. In FIGS. 6A and 6B and FIGS. 7A and 7B, the power supply 49 is not shown.

A polarization element 51c shown in FIGS. 6A and 6B and FIGS. 7A and 7B is configured so that a liquid crystal element 41a and a liquid crystal element 41b are arranged to overlap in a direction of an optical axis of incident light. FIG. 6A is a diagram showing a state in which the liquid crystal element 41a and the liquid crystal element 41b constituting the polarization element 51c are not electrically conducted. The liquid crystal element 41a and the liquid crystal element 41b are arranged so that long axis directions of liquid crystal molecules in a liquid crystal layer 47a of the liquid crystal element 41a are orthogonal to long axis directions of liquid crystal molecules in a liquid crystal layer 47b of the liquid crystal element 41b in the state in which the liquid crystal element 41a and the liquid crystal element 41b are not electrically conducted together.

Here, it is assumed that light is incident on the polarization element 51c from the liquid crystal element 41b to the liquid crystal element 41a. For example, a P-polarized component of the light incident on the polarization element 51c is blocked by the liquid crystal element 41b, and only an S-polarized component reaches the liquid crystal element 41a. However, since the liquid crystal element 41a transmits only the P-polarized component, the light incident on the liquid crystal element 41a is blocked by the liquid crystal element 41a. That is, when the liquid crystal element 41a and the liquid crystal element 41b are not electrically conducted, the polarization element 51c blocks all oscillating components, as shown in FIG. 6A.

FIG. 6B is a diagram showing a state in which only the liquid crystal element 41b among the liquid crystal elements constituting the polarization element 51c is electrically conducted. In this case, all oscillating components of light incident on the polarization element 51c are transmitted through the liquid crystal element 41b and incident on the liquid crystal element 41a. The S-polarized component of the light incident on the liquid crystal element 41a is blocked by the liquid crystal element 41a and only the P-polarized component is transmitted. Accordingly, in this case, the polarization element 51c functions as a polarizer for transmitting only the P-polarized component as a whole, as shown in FIG. 6B.

FIG. 7A is a diagram showing a state in which only the liquid crystal element 41a among the liquid crystal elements constituting the polarization element 51c is electrically conducted. In this case, the P-polarized component of light incident on the liquid crystal element 4 1b is blocked by the liquid crystal element 41b and only the S-polarized component is incident on the liquid crystal element 41a. Since the electrically conducted liquid crystal element 41a transmits all oscillating components of the light incident on the liquid crystal element 41a, all the oscillating components of the light incident on the liquid crystal element 41a, that is, only the S-polarized component is output from the liquid crystal element 41a. Accordingly, in this case, the polarization element 51c functions as a polarizer for transmitting only the S-polarized component as a whole, as shown in FIG. 7A.

Further, the liquid crystal element 41a and the liquid crystal element 41b are electrically conducted together, as shown in FIG. 7B, in order to transmit all the oscillating components of the light incident on the polarization element 51c.

As described above, as the liquid crystal element is used as the polarization element 51, a mechanical operation such as the movement or the rotation of the polarizer is not necessary when the information on the energy amount of the P-polarized component or the S-polarized component of the light reaching the light receiving element 53 is acquired. Accordingly, a configuration of the imaging apparatus is not complex and the imaging apparatus can be miniaturized and lightweight. Furthermore, since members with a mechanical operation are not necessary inside the imaging apparatus, dust can be prevented from being generated inside the imaging element.

Further, in the first embodiment, for example, acquisition of the information on the energy amounts of the P- and S-polarized components of the light reaching the light reception unit 5 is performed by a combination of any shown in <1> to <3> below of the light reflected by the light beam division element 3. In any case, the light reception unit 5 can still individually acquire the information on the energy amount of the P-polarized component and the information on the energy amount of the S-polarized component of the light reaching the light reception unit 5.

<1> (P-polarized component and S-polarized component)

<2> (P-polarized component, all oscillating components)

<3> (S-polarized component, all oscillating components)

Acquisition of information on the energy amount for any of the S-polarized component, the P-polarized component and all the oscillating component among the oscillating components of the light reaching the light reception unit 5 is switched, for example, by the movement or the rotation of the polarization element or switching of electric conduction of the liquid crystal element. The movement or the rotation of the polarization element or switching of electric conduction of the liquid crystal element is performed by a polarization element driving mechanism 61, and the polarization element driving mechanism 61 is controlled by the control signal from the signal processing unit 21. A response speed of the liquid crystal element is as high as a few milliseconds ( 1/1000 [seconds]). Accordingly, as the liquid crystal element is used as the polarization element 51, acquisition of the information on the energy amounts of the P- and S-polarized components of the light reaching the light reception unit 5 can be rapidly performed. The information on the energy amounts of the P- and S-polarized components of the light reaching the light reception unit 5, which is acquired by the light reception unit 5 is sent as the output signal from the light reception unit 5 to the signal processing unit 21.

(Calculation of Exposure Amount)

The signal processing unit 21 receives the output signal from the light reception unit 5 to perform arithmetic processing, and outputs a predicted calculation value of the intensity of the P-polarized component or a predicted calculation value of the intensity of the S-polarized component for the light beam incident on the irradiated body 7. Specifically, the signal processing unit 21 predicts an energy amount carried by the light transmitted through the light beam division element 3 in an energy amount carried by the light from the subject to calculate the amount of exposure to the irradiated body 7.

Now, it is assumed that a total energy amount carried by the light from the subject is Φ [w], a size of the P-polarized component in the total energy amount Φ [w] is Φp [w], and a size of the S-polarized component is Φs [w]. That is, it is assumed that Φ [w]=Φp [w]Φs [w]. Further, when an energy amount is simply mentioned in the present disclosure, it refers to an energy amount per unit time. It also is assumed that the reflectance and the transmittance of the light beam division element 3 for the P-polarized component of the incident light beam F are Γp and Πp, respectively. Similarly, it is assumed that the reflectance and the transmittance of the light beam division element 3 for the S-polarized component of the incident light beam F are Γs and Πs, respectively.

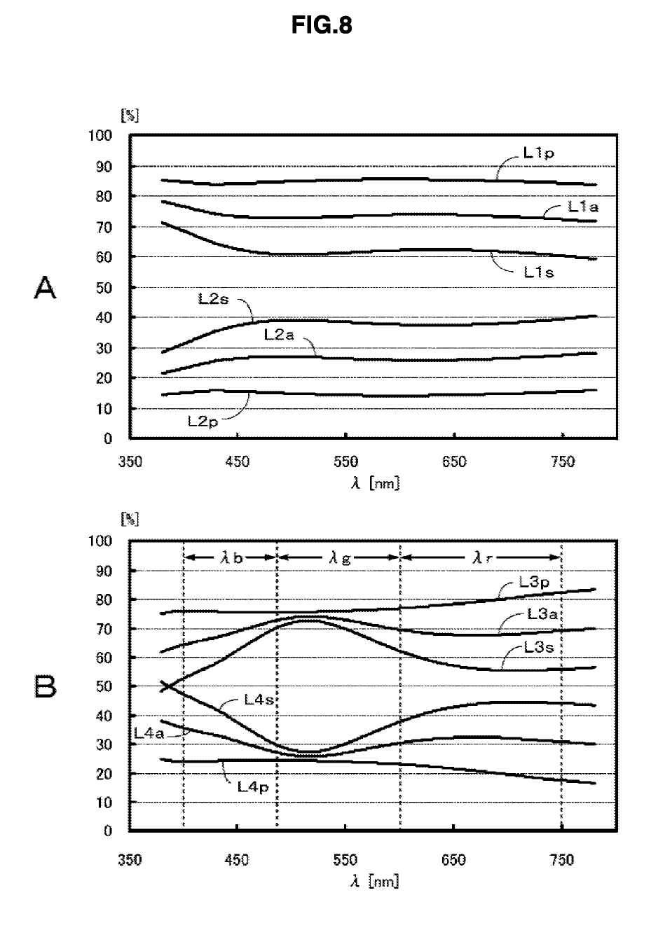

FIG. 8A is a graph showing an example of a reflection characteristic and a transmission characteristic of the light beam division element. The graph shown in FIG. 8A shows the reflectance and the transmittance for the P-polarized component of the incident light beam and the reflectance and the transmittance for the S-polarized component of the incident light beam together. Further, FIG. 8A is a graph in which a vertical axis indicates the reflectance and the transmittance and a horizontal axis indicates a wavelength λ [nm] of the light incident on the light beam division element. In FIG. 8A, L1p and L1s denote the transmittance Πp for the P-polarized component of the incident light beam and the transmittance Πs for the S-polarized component of the incident light beam, respectively, and L1a denotes an arithmetic mean of Πp and Πs. Further, in FIG. 8A, L2p and L2s denote the reflectance Γp for the P-polarized component of the incident light beam and the reflectance Γs for the S-polarized component of the incident light beam, respectively, and L2a denotes an arithmetic mean of Γp and Γs.

Generally, the transmittance Πp for the P-polarized component of the incident light beam and the transmittance Πs for the S-polarized component of the incident light beam do not become the same value, as shown in FIG. 8A. That is, the reflectance Γp for the P-polarized component of the incident light beam and the reflectance Γs for the S-polarized component of the incident light beam also do not become the same value.

A total energy amount Φr [w] of the light reaching the irradiated body 7 is predicted in the following order by the signal processing unit 21.

First, the signal processing unit 21 acquires the information on the energy amount of the P-polarized component and the S-polarized component of the light reaching the light reception unit 5 from the light reception unit 5. Since the reflectance of the light beam division element 3 for the P-polarized component of the incident light beam F is Γp and the reflectance for the S-polarized component is Γs, the energy amounts of the P- and S-polarized components of the light reaching the light reception unit 5 are (Γp*Φp) [w] and (Γs*Φs) [w], respectively.

Next, the signal processing unit 21 calls data of a reflection characteristic (a transmission characteristic) of the light beam division element 3 from the storage unit 23. The data is data of a ratio of the transmittance and the reflectance of the light beam division element 3 for each polarized component. Specifically, the data are values of (Πp/Γp) and (Πs/Γs). That is, the values of (Πp/Γp) and (Πs/Γs) are stored in the storage unit 23, in addition to the program for outputting a predicted calculation value of the intensity of the P-polarized component or a predicted calculation value of the intensity of the S-polarized component for the light beam incident on the irradiated body 7.

Next, the signal processing unit 21 calculates the energy amounts of the P- and S-polarized components of the light reaching the irradiated body 7 from the energy amount of the light reaching the light reception unit 5. For example, since the energy amount Φrp [w] of the P-polarized component of the light reaching the irradiated body 7 is (Πp*Φp) [w], the energy amount Φrp [w] may be obtained from the following Equation (1) using the energy amount of the P-polarized component of the light reaching the light reception unit 5 and the ratio of the transmittance and the reflectance of the light beam division element 3:

Φrp[w]=(Πp/Γp)*(Γp*Φp)[w] (1)

Similarly, the energy amount Φrs [w] of the S-polarized component of the light reaching the irradiated body 7 is obtained using the following Equation (2):

Φrs [w]=(Πs/Γs)*(Γs*Φs)[w] (2)

The signal processing unit 21 can output the predicted calculation value of the intensity of the P-polarized component or the predicted calculation value of the intensity of the S-polarized component for the light beam incident on the irradiated body 7 through the above-described operation. Accordingly, since the total energy amount Φr [w] of the light reaching the irradiated body 7 is obtained as a sum of Φrp [w] and Φks [w], the amount of exposure to the irradiated body 7 is calculated by the signal processing unit 21. In addition, according to the present disclosure, if the values of (Πp/Γp) and (Πs/Γs) are only prepared, the amount of exposure to the irradiated body 7 can be accurately obtained for each polarized component without depending on a polarization degree of the light from the subject. In addition, the values of (Πp/Γp) and (Πs/Γs) can be accurately measured in advance.

When the reflectance Γp and the transmittance Πp and the reflectance Γs and the transmittance Πs are substantially constant in a visible light region of a wavelength 400 nm to 750 nm (which may be called a sensitivity range of the imaging element including a color filter), an energy amount carried by the light transmitted through the light beam division element 3 can be predicted through the above operation. When the reflectance Γp and the transmittance Πp and the reflectance Γs and the transmittance Πs are not substantially constant in the visible light region, for example, the visible light region may be divided into a plurality of wavelength bands and the values of (Πp/Γp) and (Πs/Γs) may be prepared for each divided wavelength band.

FIG. 8B is a graph showing another example of the reflection characteristic and the transmission characteristic of the light beam division element. The graph shown in FIG. 8B shows the reflectance and the transmittance for the P-polarized component of the incident light beam and the reflectance and the transmittance for the S-polarized component of the incident light beam together. Further, FIG. 8B is a graph in which a vertical axis indicates the reflectance and the transmittance and a horizontal axis indicates a wavelength λ [nm] of the light incident on the light beam division element. In FIG. 8B, L3p and L3s denote the transmittance Πp for the P-polarized component of the incident light beam and the transmittance Πs for the S-polarized component of the incident light beam, respectively, and L3a denotes an arithmetic mean of Πp and Πs. Further, in FIG. 8B, L4p and L4s denote the reflectance Γp for the P-polarized component of the incident light beam and the reflectance Γs for the S-polarized component of the incident light beam, respectively, and L4a denotes an arithmetic mean of Γp and Γs.

In the example shown in FIG. 8B, for example, a difference between the transmittance Πp and the transmittance Πs (a difference between the reflectance Γp and the reflectance Γs) is small between the P-polarized component and the S-polarized component in the vicinity of λ=520 [nm]. However, for example, the difference between the transmittance Πp and the transmittance Πs (the difference between the reflectance Γp and the reflectance Γs) between the P-polarized component and the S-polarized component in the vicinity of λ=650 [nm] is greater than that in the vicinity of λ=520 [nm]. When the difference between the transmittance Πp and the transmittance Πs (the difference between the reflectance Γp and the reflectance Γs) is greatly changed according to the wavelength of the light incident on the light beam division element as described above, the visible light region is divided into a plurality of wavelength bands, and the values of (Πp/Γp) and (Πs/Γs) are prepared for each divided wavelength band.

When the light beam division element exhibits the reflection characteristic (the transmission characteristic) shown in FIG. 8B, for example, a visible light region may be divided for each color perceived from the incident light. For example, λb shown in FIG. 8B has a range of 400≦λ<490 [nm], λg has a range of 490≦λ<600 [nm], and λr has a range of 600≦λ≦750 [nm]. For example, data of the transmittance and the reflectance of the light beam division element 3 corresponding to λb, λg and λr are stored for each polarized component in the storage unit 23. That is, the storage unit 23 may store data shown in the following Table 1. It is understood that the storage unit 23 may store only the values of (Πp/Γp) and (Πs/Γs) corresponding to λb, λg and λr.

TABLE 1

| | | b | g | r |
|---|---|---|---|---|
| Transmittance [%] | p | 76 | 76 | 80 |
| | s | 60 | 70 | 56 |
| Reflectance [%] | p | 24 | 24 | 20 |
| | s | 40 | 30 | 44 |
| Ratio | (p/p) | 3.2 | 3.2 | 4.0 |
| | (s/s) | 1.5 | 2.3 | 1.3 |

The signal processing unit 21 selects the values of (Πp/Γp) and (Πs/Γs) corresponding to λb, λg and λr according to a wavelength of the light incident on the light reception unit 5, and executes the above-described operation.

Further, the division of the visible light region may be arbitrarily set, for example, for each wavelength of light transmitted through the color filter arranged together with the imaging element, for each sensitivity range of the imaging element, or the like. As the visible light region is divided into more regions, the predicted calculation value output from the signal processing unit 21 becomes more accurate.

(Adjustment of Exposure Amount)

Next, the signal processing unit 21 calculates the amount of exposure to the irradiated body 7 based on the predicted calculation value of the intensity of the P-polarized component or the predicted calculation value of the intensity of the S-polarized component for the light beam incident on the irradiated body 7, and then transmits a control signal for adjustment of the amount of exposure to the irradiated body 7. The signal processing unit 21, for example, transmits a control signal for adjusting a shutter speed of the shutter 9 to a shutter driving mechanism 63. Also, the signal processing unit 21, for example, transmits a control signal for adjusting opening of the iris 11 to an iris driving mechanism 65 included inside the lens-barrel 11 via an electrical connection 64 between the lens-barrel 1a and the main body 1b. The shutter driving mechanism 63 and the iris driving mechanism 65 set the shutter speed of the shutter 9 and an opening of the iris 11 to appropriate values according to the control signal from the signal processing unit 21.

While an exposure mode includes a P mode (program auto), an S mode (shutter priority auto), an A mode (iris priority auto) and the like, any mode may be arbitrarily selected when photographing is performed in the present disclosure. It is understood that adjustment of the exposure amount combined with ISO sensitivity (ISO speed) is possible according to, for example, a request from a photographer.

For example, the shutter speed of the shutter 9 and an opening of the iris 11 may be adjusted in consideration of the ISO sensitivity. This is because the total energy amount Φr [w] of the light reaching the irradiated body 7 is still obtained even though, in the present disclosure, Φr [w] is obtained as the sum of the individually obtained Φrp [w] and Φrs [w].

According to the present disclosure, even when a polarization degree of the incident light beam is great, the energy amount obtained by the signal processing unit does not greatly differ from the total energy amount of the light actually reaching the irradiated body 7. Further, a set of processes described above are executed by the signal processing unit 21 according to a control program stored in the storage unit 23.

[Application Example of Automatic Exposure] (Cooperation with Continuous Shooting Function)

According to the present disclosure, a single picture for a subject in which a polarization degree of the incident light beam is great (hereinafter described as “polarization subject”) and a subject in which the polarization degree of the incident light beam is small (hereinafter described as “general subject”) can be obtained with appropriate exposure for each subject. According to the method of calculating an exposure amount in the present disclosure, for example, when a person standing on a bank of a pond is photographed, appropriate exposure can be obtained even with metering of a reflected light from a water surface (the polarization subject). However, the exposure amount determined based on the light from the polarization subject is not necessarily an exposure amount suitable for photographing the person standing on a bank of a pond (the general subject). In general, the photographer selects whether the exposure amount is set for the polarization subject or the general subject.

According to the present disclosure, the amount of exposure to the irradiated body 7 can be set to be appropriate without depending on the polarization degree of the light from the subject and without needing exchange of the optical filter, or the like. When the polarization subject and the general subject are obtained as a single picture, the imaging apparatus 1 first measures the light from one of the subjects to set appropriate exposure and captures the subject as a metering target. At a short interval, the imaging apparatus 1 measures the light from the other subject to set appropriate exposure and captures the subject as a metering target. That is, the photographer continuously shoots respective subjects using the imaging apparatus 1 while taking the respective subjects as metering targets.

Then, the imaging apparatus 1 acquires picture information on the respective subjects subjected to the appropriate exposure. Accordingly, for example, picture processing to synthesize the picture information on the respective subjects can be performed by the signal processing unit 21. A picture obtained by performing picture processing is a single picture obtained by photographing each of the polarization subject and the general subject with an appropriate exposure amount.

Further, the present disclosure may be applied to, for example, a photographing method of performing photographing while continuously changing a direction or a position of a camera to obtain a single picture. According to the present disclosure, for example, a landscape around a photographer may be photographed in a 360° range to be contained in a single picture. In this case, even when both a bright portion and a dark portion are present in a range desired to be contained in the single picture, the imaging apparatus 1 continuously performs automatic metering and exposure adjustment. Accordingly, the photographer can put an entire photographic range in appropriate exposure without a complex manipulation. For example, the photographer can take one panoramic photograph containing blue sky and buildings or take a panoramic photograph of broad snowy mountains or sea of clouds without having to worry about the exposure amount.

(Cooperation with Moving-Picture Photographing Function)

The present disclosure may also be applied to a camera having a moving-picture photographing function. A camera with a pellicle mirror has a feature in that autofocus and display of a current subject image on the display unit 17 can be simultaneously performed when a moving picture is photographed. Further, the camera with a pellicle mirror can perform metering for calculation of the exposure amount during moving picture photography. Accordingly, application of the present disclosure to the camera with a pellicle mirror having a moving-picture photographing function enables photographing to be performed on a fast moving subject with an appropriate exposure amount according to a photographed scene while adjusting focus.

For example, if the user of the imaging apparatus 1 instructs the imaging apparatus 1 to start photographing, the imaging apparatus 1 starts subject imaging using the imaging element and starts acquisition of the information on the energy amount of the light reaching the light reception unit 5 using the light reception unit 5. Here, for example, it is assumed that the light reception unit 5 individually acquires information on the energy amount for the P-polarized component and information on the energy amount for the S-polarized component. In this case, the acquisition of the information on the energy amounts of the P- and S-polarized components is executed, for example, when the photographed scene is switched (hereinafter appropriately described as a scene change).

Since subject imaging is continuously performed by the imaging element during moving picture photography, a determination as to whether there was the scene change can be made based on the result of picture-recognizing an output signal from the imaging element. For example, the signal processing unit 21 picture-recognizes the output signal from the imaging element and determines whether there was the scene change. Examples of an algorithm for detecting the scene change include a pixel difference detection method, a motion vector detection method, or a combination thereof.

The acquisition of the information on the energy amounts of the P- and S-polarized components may be executed in a previously set period, instead of determining whether there was the scene change based on the result of picture-recognizing the output signal from the imaging element. For example, when a moving picture having a frame rate of 24 [fps (frame per second)] is photographed, the information on the energy amounts of the P- and S-polarized components may be set to be acquired every 1/24 seconds. It is understood that the acquisition period of the information on the energy amounts of the P- and S-polarized components is not limited thereto and may be arbitrarily set.

Since the imaging apparatus 1 can perform metering for calculation of the exposure amount even during moving picture photography, the acquisition of the information on the energy amounts of the P- and S-polarized components may continue to be executed all the times during moving picture photography. In this case, the acquisition of the information on the energy amount of the P-polarized component and the acquisition of the information on the energy amount of the S-polarized component are continuously switched. When the light reception unit 5 includes the polarization element 51 configured of an liquid crystal element, since the response speed of the liquid crystal element is a high as a few milliseconds as described above, the acquisition of the information on the energy amount of the P-polarized component and the acquisition of the information on the energy amount of the S-polarized component can be switched easily and rapidly.

As the acquisition of the information on the energy amounts of the P- and S-polarized components is executed during moving picture photography, over-exposure is not caused in an obtained picture immediately after the user of the imaging apparatus 1, for example, suddenly moves from a dark place to a bright place.

Further, a subject image obtained by the imaging element is displayed on the display unit 17 during moving picture photography. In this case, the amount of the light beam reaching the imaging element is adjusted by the iris 11.

The signal processing unit 21 executes calculation of the energy amounts of the P- and S-polarized components of the light reaching the imaging element based on the information acquired by the light reception unit 5, and transmits a control signal for adjusting opening of the iris 11 to the iris driving mechanism 63. The opening of the iris 11 is adjusted by the iris driving mechanism 63 having received the control signal transmitted from the signal processing unit 21. Accordingly, when the adjustment of the opening of the iris 11 follows the acquisition of the information on the energy amounts of the P- and S-polarized components, a subject image is displayed on the display unit 17 as an image of the user of the imaging apparatus 1 is. Continuing to adjust the opening of the iris 11 during moving picture photography is not realistic, but the adjustment of the opening of the iris 11 may be set to be executed, for example, only when the amount of the light beam reaching the imaging element is predicted to exceed a previously set threshold.

Further, the signal from the imaging element is supplied to the display unit 17 as a picture signal subjected to picture processing in the signal processing unit 21. The signal processing unit 21 may correct the signal from the imaging element when picture processing is performed, based on the predicted calculation value of the amount of the light beam reaching the imaging element. Alternatively, the signal processing unit 21 may adjust sensitivity of the imaging element based on the predicted calculation value of the amount of the light beam reaching the imaging element.

In either of the adjustment of the opening of the iris 11 or the correction of the signal from the imaging element based on the predicted calculation value of the amount of the light beam reaching the imaging element, a subject image is displayed on the display unit 17 as an image of the user of the imaging apparatus 1 is. Thus, according to the present disclosure, the amount of exposure to the imaging element can be accurately obtained for each polarized component of light incident on the imaging element, such that washed-out color is not generated in the picture displayed on the display unit 17 and the user of the imaging apparatus 1 can faithfully capture a moving picture.

### Variant of First Embodiment

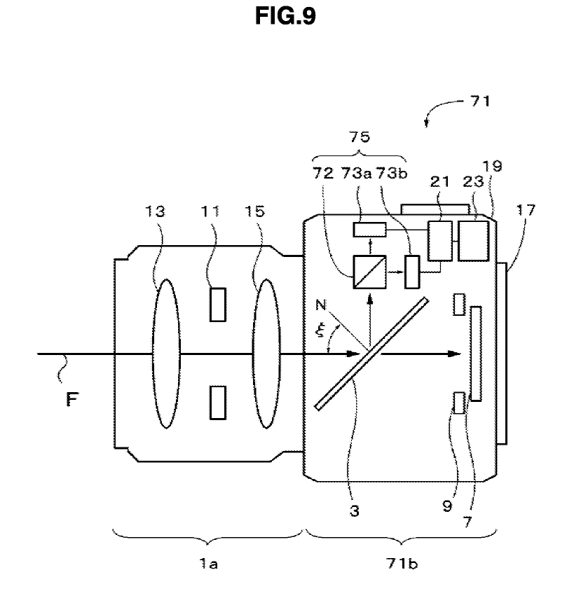

FIG. 9 is a schematic diagram showing a schematic configuration of a variant of the imaging apparatus according to the first embodiment. The imaging apparatus 71 shown in FIG. 9 is the same as the imaging apparatus 1 shown in FIG. 1 in that it includes a light beam division element 3, an irradiated body 7, a signal processing unit 21, a shutter 9, and an iris 11. A light reception unit 75 is arranged instead of the light reception unit 5 inside a main body 7 1b of the imaging apparatus 71 shown in FIG. 9. The imaging apparatus 71 shown in FIG. 9 differs from the imaging apparatus 1 shown in FIG. 1 in that the light reception unit 75 includes a polarization beam splitter 72, a light receiving element 73a and a light receiving element 73b.

The light beam division element 3 reflects a part of a light beam F incident on the imaging apparatus 1 and transmits a residual light beam to divide the incident light beam F into, for example, two light beams. One of the light beams divided by the light beam division element 3 is incident on the light reception unit 75.

The light beam incident on the light reception unit 75 is further split into a P-polarized component and a S-polarized component by the polarization beam splitter 72, and the P-polarized component and the S-polarized component of the light beam incident on the light reception unit 75 are incident on the light receiving element 73a and the light receiving element 73b, respectively. That is, in the imaging apparatus 1, acquisition of an intensity of the P-polarized component and acquisition of an intensity of the S-polarized component for the light beam incident on the light reception unit 75 are sequentially performed, while in the imaging apparatus 71, acquisition of the intensity of the P-polarized component and acquisition of the intensity of the S-polarized component for the light beam incident on the light reception unit 75 are simultaneously performed.

The intensity of the P-polarized component or the intensity of the S-polarized component acquired by the light reception unit 75 is input to the signal processing unit 21. The imaging apparatus 71 is the same as the imaging apparatus 1 in that the adjustment of the shutter speed of the shutter 9 or the opening of the iris 11 is executed according to the predicted calculation value of the intensity of the P-polarized component or the intensity of the S-polarized component for the light beam incident on the irradiated body 7, which is output by the signal processing unit 21.

Here, the polarization beam splitter 72 is an optical element for reflecting a part of the incident light therein and transmitting residual light. That is, light incident on the light receiving element 73a and the light receiving element 73b is light reflected by or transmitted through a junction surface (a beam branch surface) inside the polarization beam splitter 72. Accordingly, the intensity of the P-polarized component for the light beam incident on the light receiving element 73a depends on a reflection characteristic of the junction surface inside the polarization beam splitter 72, and differs from the intensity of the P-polarized component of the light beam incident on the light reception unit 75. Similarly, the intensity of the S-polarized component for the light beam incident on the light receiving element 73b differs from the intensity of the S-polarized component of the light beam incident on the light reception unit 75.

In this case, the intensity of the P-polarized component or the intensity of the S-polarized component for the light beam incident on the irradiated body 7 is predicted from the intensity of the P-polarized component acquired by the light receiving element 73a or the intensity of the S-polarized component acquired by the light receiving element 73b as follows.

First, values of ratios (Πp₁/Γp₁) and (Πs₁/Γs₁) of the transmittance and the reflectance of the light beam division element 3 are accurately measured for the respective polarized components in advance. Here, it is assumed that the transmittance and the reflectance of the light beam division element 3 for the P-polarized component are Πp₁ and Γp₁, respectively, and the transmittance and the reflectance for the S-polarized component are Πs₁ and Γs₁, respectively. Further, a transmittance value Πp₂ of the junction surface inside the polarization beam splitter 72 for the P-polarized component and a reflectance value Γs₂ for the S-polarized component have been accurately measured in advance.

In the imaging apparatus 71, data of a reflection characteristic (transmission characteristic) of the junction surface inside the polarization beam splitter 72 is further stored in the storage unit 23, in addition to the data of the reflection characteristic (the transmission characteristic) of the light beam division element 3. That is, the values of (Πp₁/Γp₁), (Πs₁/Γs₁), Πp₂ and Γs₂ are stored in the storage unit 23.

When the size of the P-polarized component in the energy amount carried by the light from the subject is Φp [w] and a size of the S-polarized component is Φs [w], the energy amount of the P-polarized component of light reaching the light receiving element 73a is represented as (Πp₂*Γp₁*Φp) [w]. Similarly, the energy amount of the S-polarized component of light reaching the light receiving element 73b is represented as (Γs₂*Γs₁*Φs) [w].

Accordingly, the energy amount Φrp [w] of the P-polarized component of the light reaching the irradiated body 7 and the energy amount Φrs [w] of the S-polarized component of the light reaching the irradiated body 7 may be obtained using the following Equations (3) and (4), respectively:

Φrp [w]=(Πp₁/Γp₁)*(1/Πp₂)*(Πp₂*Γp₁*Φp)[w] (3)

Φrs [w]=(Πs₁/Γs₁)*(1/Γs₂)*(Γs₂*Γs₁*Φs)[w] (4)

Thus, one of the light beams divided by the light beam division element 3 may be reflected by or transmitted through another optical element and the intensity of the P-polarized component or the intensity of the S-polarized component for the light beam may be acquired. In this case, if the reflection characteristic (the transmission characteristic) of the optical element other than the light beam division element 3 has been recognized for each polarized component in advance, the intensity of the P-polarized component or the intensity of the S-polarized component for the light beam incident on the irradiated body 7 can be accurately predicted.

### 2. Second Embodiment

### [Schematic Configuration of Imaging Apparatus]

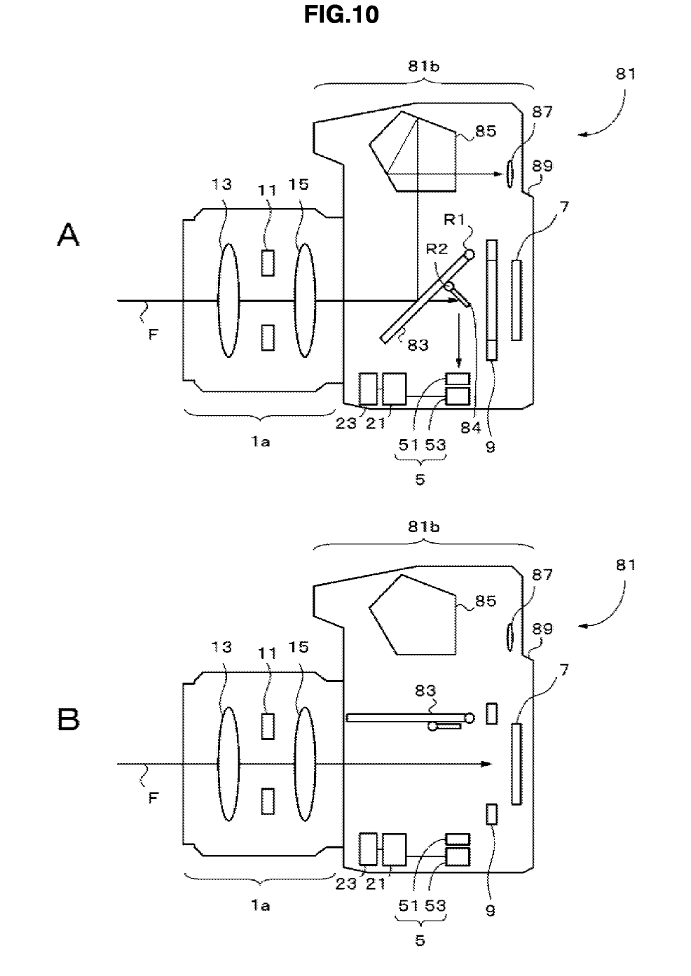

FIGS. 10A and 10B are schematic diagrams showing a schematic configuration of an imaging apparatus according to a second embodiment. FIG. 10A is a diagram showing a state before a shutter button of an imaging apparatus 81 is pressed, and FIG. 10B is a diagram showing a state in which the shutter button of the imaging apparatus 81 is pressed. As shown in FIGS. 10A and 10B, the imaging apparatus 81 according to the second embodiment is the same as the imaging apparatus 1 shown in FIG. 1 in that it includes a light reception unit 5, an irradiated body 7, a signal processing unit 21, a shutter 9, and an iris 11. A set of a translucent mirror 83 and a sub mirror 84 is arranged instead of the light beam division element 3 inside a main body 81b of the imaging apparatus 81 shown in FIGS. 10A and 10B. The translucent mirror 83 is supported by a rotation axis R1 arranged in the housing 89. The sub mirror 84 is supported by a rotation axis R2 arranged in the translucent mirror 83. Specifically, the imaging apparatus 81 according to the second embodiment is, for example, a single-lens reflex camera. The present disclosure may also be applied to the single-lens reflex camera.

### [Operation of Imaging Apparatus]

In a state before the photographer presses the shutter button, the translucent mirror 83 reflects a part of a light beam F incident on the imaging apparatus 81 and transmits a residual light beam to divide the incident light beam F into, for example, the two light beams. The light reflected by the translucent mirror 83 is incident on a pentaprism 85 arranged over the translucent mirror 83. The light incident on the pentaprism 85 is iteratively totally reflected inside the pentaprism 85 and reaches a finder including an eyepiece lens 87.

On the other hand, a part of light transmitted through the translucent mirror 83 is incident on the sub mirror 84. Further, residual light not incident on the sub mirror 84 in the light transmitted through the translucent mirror 83 proceeds to the irradiated body 7, but the light proceeding to the irradiated body 7 is blocked by the shutter 9 and does not reach the irradiated body 7. The light incident on the sub mirror 84 is reflected by the sub mirror 84. The light reflected by the sub mirror 84, for example, proceeds to a distance measuring sensor arranged below the translucent mirror 83.

For example, a light reception unit 5 may be arranged below the translucent mirror 83. In the configuration example shown in FIGS. 10A and 10B, the light reflected by the sub mirror 84 is incident on the light reception unit 5 arranged below the translucent mirror 83. The light reception unit 5 acquires an intensity of a P-polarized component or an intensity of an S-polarized component for the light beam incident on the light reception unit 5, similar to the first embodiment. The intensity of the P-polarized component or the intensity of the S-polarized component acquired by the light reception unit 5 is input to the signal processing unit 21, similar to the first embodiment.

If the photographer presses the shutter button, the set of translucent mirror 83 and sub mirror 84 jumps up, the shutter 9 is opened, and the light beam F incident on the imaging apparatus 81 reaches the irradiated body 7. In this case, at least one of a shutter speed of the shutter 9 or an opening of the iris 11 is adjusted according to an output from the signal processing unit 21, similar to the first embodiment. The adjustment of the shutter speed of the shutter 9 or the opening of the iris 11 is executed according to a predicted calculation value of the intensity of the P-polarized component or a predicted calculation value of the intensity of the S-polarized component for the light beam incident on the irradiated body 7, which is output by the signal processing unit 21.

(Calculation of Exposure Amount)

Even in the second embodiment, the light reception unit 5 acquires the intensity of the P-polarized component or the intensity of the S-polarized component for the light beam incident on the light reception unit 5, similar to the first embodiment. The second embodiment differs from the first embodiment in that the light incident on the light reception unit 5 is light transmitted through the translucent mirror 83 and then further reflected by the sub mirror 84, and the light beam reaching the irradiated body 7 is not a part of the incident light beam F, but rather is the entire incident light beam F.

Here, it is assumed that transmittance of the translucent mirror 83 for the P-polarized component is Πp₁, and transmittance for the S-polarized component is Πs₁. It is also assumed that reflectance of the sub mirror 84 for the P-polarized component is Γp₂ and reflectance for the S-polarized component is Γs₂. It is assumed that values of Πp₁, Πs₁, Γp₂ and Γs₂ are stored in the storage unit 23, in addition to a program for outputting a predicted calculation value of the intensity of the P-polarized component or a predicted calculation value of the intensity of the S-polarized component for the light beam incident on the irradiated body 7. In this case, the signal processing unit 21 receives the output signal from the light reception unit 5 to perform arithmetic processing in the following order and outputs the predicted calculation value of the intensity of the P-polarized component or the predicted calculation value of the intensity of the S-polarized component for the light beam incident on the irradiated body 7.

If the size of the P-polarized component in an energy amount carried by the light from the subject is Φp [w] and a size of the S-polarized component is Φs [w], the energy amount of the P-polarized component of the light reaching the light reception unit 5 is represented as (Γp₂*Πp₁*Φp) [w]. Similarly, the energy amount of the S-polarized component of the light reaching the light reception unit 5 is represented as (Γs₂*Πs₁*Φs) [w]. The signal processing unit 21 receives these values and outputs the predicted calculation value of the intensity of the P-polarized component or the predicted calculation value of the intensity of the S-polarized component for the light beam incident on the irradiated body 7 using the values of Πp₁, Πs₁, Γp₂ and Γs₂ stored in the storage unit 23.

Specifically, the signal processing unit 21 calculates the energy amount Φrp [w] of the P-polarized component of the light reaching the irradiated body 7 and the energy amount Φrs [w] of the S-polarized component of the light reaching the irradiated body 7 using the following Equations (5) and (6).

Φrp [w]=(1/Γp₂)*(1/Πp₁)*(Γp₂*Πp₁*Φp)[w] (5)

Φrs [w]=(1/Γs₂)*(1/Πs₁)*(Γs₂*Πs₁*Φs)[w] (6)

According to the second embodiment, the photographer can confirm a current subject image through an optical finder and then performs photography. In addition, since the imaging apparatus 81 adjusts the exposure amount to be an appropriate value, the photographer can obtain a faithful reproduction as expected.

### Variant of Second Embodiment

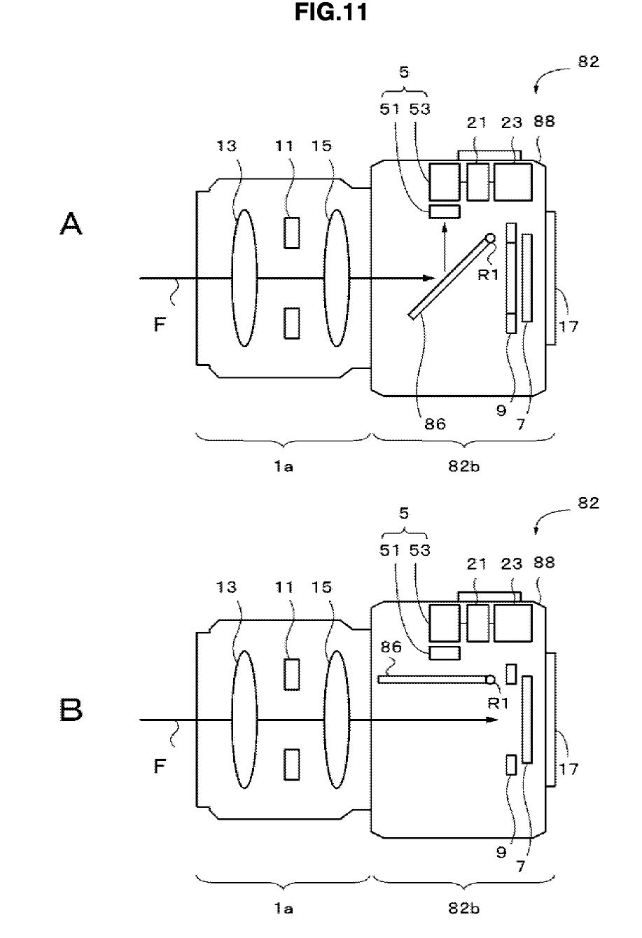

FIGS. 11A and 11B are schematic diagrams showing a schematic configuration of a variant of the imaging apparatus according to the second embodiment. FIG. 11A is a diagram showing a state before a shutter button of an imaging apparatus 82 is pressed, and FIG. 11B is a diagram showing a state in which the shutter button of the imaging apparatus 82 is pressed. As shown in FIGS. 11A and 11B, the imaging apparatus 82 may include a movable minor 86 supported by a rotation axis R1 arranged inside a housing 88, instead of the set of translucent mirror 83 and sub mirror 84.

The configuration example shown in FIGS. 11A and 11B is the same as the imaging apparatus 1 according to the first embodiment in that light incident on a light reception unit 5 is light reflected by the movable minor 86. The configuration example shown in FIGS. 11A and 11B differs from the imaging apparatus 1 according to the first embodiment, but is the same as the imaging apparatus 81 in that the light beam reaching the irradiated body 7 is not a part of the incident light beam F, but is the entire incident light beam F.

In the configuration example shown in FIGS. 11A and 11B, the signal processing unit 21 can calculate the energy amount Φrp [w] of the P-polarized component of the light reaching the irradiated body 7 by using the value of (1/Γp) instead of the value of (Πp/Γp) in Equation (1) described above. Also, the signal processing unit 21 can calculate the energy amount Φrs [w] of the S-polarized component of the light reaching the irradiated body 7 by using the value of (1/Γs) instead of the value of (Πs/Γs) in Equation (2) described above.

### 3. Third Embodiment

A light amount measurement apparatus capable of outputting an intensity for a light beam irradiated to an irradiation target to the outside is obtained by the light beam division element, the light reception unit and the signal processing unit.

### [Schematic Configuration of Light Amount Measurement Apparatus]

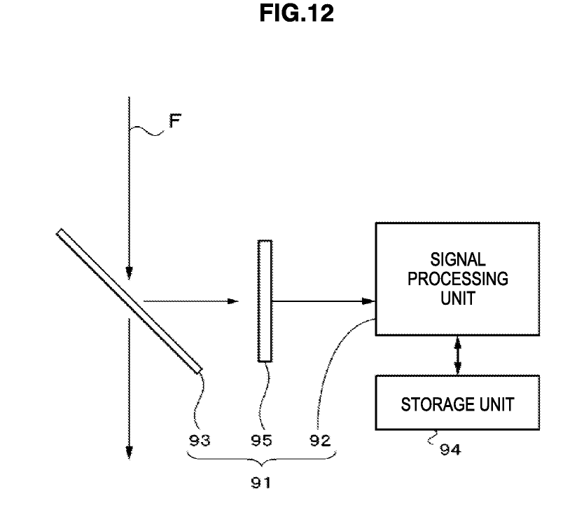

FIG. 12 is a block diagram showing a configuration example of a light amount measurement apparatus according to a third embodiment. As shown in FIG. 12, the light amount measurement apparatus 91 according to the third embodiment includes a light beam division element 93, a light reception unit 95, and a signal processing unit 92. In the configuration example shown in FIG. 12, a storage unit 94 is connected to the signal processing unit 92. Further, the same configurations as those of the light beam division element 3, the light reception unit 5, the signal processing unit 21 and the storage unit 23 according to the first embodiment may be applied to the light beam division element 93, the light reception unit 95, the signal processing unit 92 and the storage unit 94, respectively.

The light beam division element 93 reflects a part of a light beam F incident on the light amount measurement apparatus 91 and transmits a residual light beam to divide the incident light beam F into, for example, the two light beams. One of the light beams divided by the light beam division element 93 is incident on the light reception unit 95. The light reception unit 95 acquires an intensity of a P-polarized component or an intensity of an S-polarized component for the light beam incident on the light reception unit 95. The intensity of the P-polarized component or the intensity of the S-polarized component acquired by the light reception unit 95 is input to the signal processing unit 92. The signal processing unit 92 outputs a predicted calculation value of the intensity of the P-polarized component or a predicted calculation value of the intensity of the S-polarized component for the other light beam divided by the light beam division element 93. A predicted calculation value of an intensity of all oscillating components for the light beam is obtained as a sum of the predicted calculation value of the intensity of the P-polarized component and the predicted calculation value of the intensity of the S-polarized component, which are output from the signal processing unit 92.

Accordingly, according to the third embodiment, when the other light beam divided by the light beam division element 93 is irradiated to an irradiation target, intensities for all oscillating components for the light beam irradiated to the irradiation target can be measured without directly measuring the intensity for the light beam.

### EXAMPLES

Hereinafter, the present disclosure will be described in detail in connection with examples, but the present disclosure is not limited to the examples.

### Embodiment 1

First, evaluation of an exposure amount calculated when the polarization subject is photographed on the assumption of an imaging apparatus having the same configuration as the first embodiment was performed.

In a translucent mirror arranged as the light beam division element inside the imaging apparatus, it was assumed that the reflectance and the transmittance for the P-polarized component of the incident light beam are 20% and 80%, respectively, and the reflectance and the transmittance for the S-polarized component are 40% and 60%, respectively. That is, Γp=20 [%], Πp=80 [%], Γs=40 [%], and Πs=60 [%] were assumed. Accordingly, 4.0 and 1.5 are stored corresponding to each other as the values of (Πp/Γp) and (Πs/Γs) in the storage unit of the imaging apparatus.

Next, the total energy amount carried by the light from the subject was assumed to be 100 [w], a size of the P-polarized component in the total energy amount was assumed to be 70 [w], and a size of the S-polarized component was assumed to be 30 [w]. That is, a polarization subject in which energy amounts carried by the light from the subject are Φp=70 [w] and Φs=30 [w] was assumed as a subject.

In this case, the energy amounts of the P- and S-polarized components of the light reaching the light reception unit of the imaging apparatus are calculated to be (Γp*Φp)=14 [w] and (Γs*Φs)=12 [w], respectively.

The energy amount Φrp [w] of the P-polarized component of the light reaching the irradiated body, which is obtained by the signal processing unit, is Φrp=4.0*14=56 [w] from the above Equation (1). Similarly, the energy amount Φsp [w] of the S-polarized component of the light reaching the irradiated body is Φrs=1.5*12=18 [w] from the above Equation (2). Accordingly, the total energy amount Φr [w] of the light reaching the irradiated body is obtained as Φr=Φrp+Φs=74 [w].

This is equal to 74 [w], which is the total energy amount of the light actually reaching the irradiated body calculated as (Πp*Φp)+(Πs*Φs) [w].

That is, the signal processing unit predicts, for the P-polarized component, that an energy amount that is 4.0 times the energy amount of the light reaching the light reception unit reaches the irradiated body. Also, the signal processing unit predicts, for the S-polarized component, that an energy amount that is 1.5 times the energy amount of the light reaching the light reception unit reaches the irradiated body. Accordingly, the signal processing unit can accurately predict the total energy amount of the light reaching the irradiated body and the signal processing unit can set the shutter speed of the shutter and an opening of the iris to appropriate values based on the prediction.

Next, evaluation of the exposure amount calculated when the general subject is photographed instead of the polarization subject was performed.

The total energy amount carried by the light from the subject was assumed to be 100 [w], a size of the P-polarized component in the total energy amount was assumed to be 50 [w], and a size of the S-polarized component was assumed to be 50 [w]. That is, a general subject in which energy amounts carried by the light from the subject is Φp=50 [w] and Φs=50 [w] was assumed as a subject.

In this case, the energy amounts of the P- and S-polarized components of the light reaching the light reception unit of the imaging apparatus are calculated as (Γp*Φp)=10 [w] and (Γs*Φs)=20 [w], respectively.

The energy amount Φrp [w] of the P-polarized component of the light reaching the irradiated body, which is obtained by the signal processing unit, is Φrp=4.0*10=40 [w] from the above Equation (1). Similarly, the energy amount of the S-polarized component Φrs [w] of the light reaching the irradiated body is Φrs=1.5*20=30 [w] from the above Equation (2). Accordingly, the total energy amount Φr [w] of the light reaching the irradiated body is obtained as Φr=Φrp+Φrs=70 [w].

This is equal to 70 [w] that is the total energy amount of light actually reaching the irradiated body, which is calculated as (Πp*Φp)+(Πs*Φs) [w]. That is, according to the present disclosure, it was found that the amount of exposure to the irradiated body can be accurately obtained without depending on a polarization degree of the light from the subject.

### Comparative Example 1

Next, evaluation of an exposure amount calculated when a polarization subject is photographed on the assumption of an imaging apparatus for performing metering of the light reaching the light reception unit without distinction between the P-polarized component and the S-polarized component and predicting a total energy amount of the light reaching the irradiated body based on the metering result was performed.

In this case, for example, a ratio (Πa/Γa) of an arithmetic mean Πa [%] of Πp and Πs and an arithmetic mean Γa [%] of Γp and Γs is stored in the storage unit of the imaging apparatus. Further, when Γp=20 [%], Πp=80 [%], Γs=40 [%], and Πs=60 [%], the value of (Πa/Γa) is about 2.3, similar to example 1.

In this case, the total energy amount of the light reaching the light reception unit of the imaging apparatus is (Γp*Φp)+(Γs*Φs)=26 [w]. In the imaging apparatus of comparative example 1, the signal processing unit predicts the total energy amount Φr [w] of the light reaching the irradiated body from the total energy amount of the light reaching the light reception unit and the value of (Πa/Γa).

That is, the signal processing unit predicts the total energy amount Φr [w] of the light reaching the irradiated body using the following Equation (7).

Φr [w]=(Πa/Γa)*{(Γp*Φp)+(Γs*Φs)} [w] (7)

Accordingly, the total energy amount Φr [w] of the light reaching the irradiated body is obtained to be about 61 [w] by the signal processing unit. However, the total energy amount of the light reaching the irradiated body, which is predicted by the signal processing unit, is not equal to 74 [w] that is the total energy amount of the light actually reaching the irradiated body, which is calculated as (Πp*Φp)+(Π*Φs) [w]. That is, it is difficult for the signal processing unit to accurately predict the total energy amount of the light reaching the irradiated body, and the shutter speed of the shutter and an opening of the iris set by the signal processing unit based on the prediction are not appropriate values.

### Example 2

Next, evaluation of an exposure amount calculated when the polarization subject is photographed on the assumption of an imaging apparatus having the same configuration as the variant of the second embodiment was performed.

Even in a movable minor arranged as the light beam division element inside the imaging apparatus, Γp=20 [%], Πp=80 [%], Γs=40 [%], and Πs=60 [%] were assumed, similar to example 1. Accordingly, 5.0 and 2.5 are stored corresponding to each other as the values of (1/Γp) and (1/Γs) in the storage unit of the imaging apparatus.

Next, the total energy amount carried by the light from the subject was assumed to be 100 [w], a size of the P-polarized component in the total energy amount was assumed to be 70 [w], and a size of the S-polarized component was assumed to be 30 [w]. That is, a polarization subject in which energy amounts carried by the light from the subject are Φp=70 [w] and Φs=30 [w] was assumed as a subject.

In this case, the energy amounts of the P- and S-polarized components of the light reaching the light reception unit of the imaging apparatus are calculated as (Γp*Φp)=14 [w] and (Γs*Φs)=12 [w], respectively.

The energy amount Φrp [w] of the P-polarized component of the light reaching the irradiated body obtained by the signal processing unit is Φrp=5.0*14=70 [w] by replacing (Πp/Γp) with (1/Γp) in Equation (1) described above. Similarly, the energy amount Φsp [w] of the S-polarized component of the light reaching the irradiated body is Φrs=2.5*12=30 [w] by replacing (Πs/Γs) with (1/Γs) in Equation (2) described above. Accordingly, the total energy amount Φr [w] of the light reaching the irradiated body is obtained as Φr=Φrp+Φrs=100 [w].

This is equal to 100 [w] that is the total energy amount of the light actually reaching the irradiated body (the total energy amount carried by the light from the subject). That is, it was found that the amount of exposure to the irradiated body can be accurately obtained even when the present disclosure is applied to a single-lens reflex camera.

### Comparative Example 2

Next, evaluation of an exposure amount calculated when a polarization subject is photographed on the assumption of an imaging apparatus for performing metering of the light reaching the light reception unit without distinction between the P-polarized component and the S-polarized component and predicting a total energy amount of the light reaching the irradiated body based on the metering result was performed.

In this case, for example, a ratio (1/Γa) is stored in the storage unit of the imaging apparatus, in which an arithmetic mean of Γp and Γs is assumed to be Γa [%]. Further, when Γp=20 [%], Πp=80 [%], Γs=40 [%], and Πs=60 [%], a value of (1/Γa) is about 3.3, similar to the case of example 2.

In this case, the total energy amount of the light reaching the light reception unit of the imaging apparatus is (Γp*Φp)+(Γs*Φs)=26 [w]. In the imaging apparatus of comparative example 2, the signal processing unit predicts the total energy amount Φr [w] of the light reaching the irradiated body from the total energy amount of the light reaching the light reception unit and the value of (1/Γa).

That is, the signal processing unit predicts the total energy amount Φr [w] of the light reaching the irradiated body using the following Equation (8).

Φr [w]=(1/Γa)*{(Γp*Φp)+(Γs*Φs)} [w] (8)

Accordingly, the total energy amount Φr [w] of the light reaching the irradiated body is obtained as about 87 [w] by the signal processing unit. However, the total energy amount of the light reaching the irradiated body, which is predicted by the signal processing unit, is not equal to 100 [w], which is the total energy amount of the light actually reaching the irradiated body (the total energy amount carried by the light from the subject). That is, the signal processing unit does not accurately predict the total energy amount of the light reaching the irradiated body, and the shutter speed of the shutter and an opening of the iris set by the signal processing unit based on the prediction are not appropriate values.

As described above, according to the present disclosure, without depending on the polarization degree of the light from the subject, the amount of exposure to the irradiated body can be accurately obtained, and photographing can be performed with an appropriate exposure amount even when the polarization subject is photographed. It is understood that photographing can be performed with the appropriate exposure amount even when the general subject is photographed. When both the polarization subject and the general subject are present, photographing can be performed with an appropriate exposure amount. Furthermore, in the present disclosure, since metering is performed with distinction between the P-polarized component and the S-polarized component, accuracy of the set exposure amount is improved as compared to when the metering is performed without distinction between the P-polarized component and the S-polarized component.

Further, the photographer can leave the adjustment of an exposure amount to the imaging apparatus and a photographer having no particular knowledge or experience can faithfully photograph a subject.

### 4. Variant

While the preferred embodiment has been described above, a preferred concrete example is not limited to the above description and various changes may be made.

For example, while the camera has been illustrated as the imaging apparatus in the above-described embodiment, the present disclosure may also be applied to a video camera.

Since the present disclosure does not need a particular optical part, the imaging apparatus or the light amount measurement apparatus can be miniaturized and lightweight. For example, a combination with an electronic device such as a personal digital assistance (PDA), a mobile phone, a smart phone, an electronic diary, a laptop computer or the like is possible.

Further, a metering scheme is not particularly limited and, for example, spot metering or partial metering may be applied, in addition to full metering, center-weighted metering, or multi-segment metering.

The configuration, the method, the shape, the material and the value in the above-described embodiments are merely examples, and other configurations, methods, shapes, materials and values may be used, as necessary. The configuration, method, shape, material and value of the above-described embodiments may be combined without departing from the scope and the sprit of the present disclosure.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1)

An imaging apparatus comprising:

a light beam division element for dividing an incident light beam into a first light beam and a second light beam;

a light reception unit on which the first light beam is incident, for acquiring an intensity of a P-polarized component or an intensity of an S-polarized component for the first light beam;

an irradiated body on which the second light beam is incident;

a signal processing unit for outputting a predicted calculation value of an intensity of a P-polarized component or a predicted calculation value of an intensity of an S-polarized component for the second light beam, from the intensity of the P-polarized component or the intensity of the S-polarized component acquired by the light reception unit;

a shutter for switching incidence and blocking of the second light beam on and to the irradiated body; and

an iris for adjusting an amount of the second light beam reaching the irradiated body,

wherein at least one of a shutter speed of the shutter or an opening of the iris is adjusted according to an output from the signal processing unit.
(2)

The imaging apparatus according to (1), further comprising:

a storage unit for storing a ratio of transmittance of the light beam division element for the P-polarized component and reflectance of the light beam division element for the P-polarized component and a ratio of transmittance of the light beam division element for the S-polarized component and reflectance of the light beam division element for the S-polarized component.
(3)

The imaging apparatus according to (1) or (2), wherein

an angle between a normal to a reflection surface of the light beam division element and an optical axis of the incident light beam is constant.
(4)

The imaging apparatus according to (1) or (2), wherein the light beam division element is evacuated from the incident light beam when the second light beam is incident on the irradiated body.
(5)

The imaging apparatus according to any one of (1) to (4), wherein the light reception unit includes a polarization element and a light receiving element.
(6)

The imaging apparatus according to (5), wherein the polarization element includes a liquid crystal element.
(7)

The imaging apparatus according to any one of (1) to (6), wherein the signal processing unit outputs the predicted calculation value for each divided wavelength band.
(8)

The imaging apparatus according to any one of (1) to (7), wherein

acquisition of the intensity of the P-polarized component or the intensity of the S-polarized component for the first light beam in the light reception unit is continuously performed when the first light beam is incident on the light reception unit.
(9)

The imaging apparatus according to any one of (1) to (8), wherein

the irradiated body is an imaging element.
(10)

The imaging apparatus according to any one of (1) to (9), wherein

acquisition of the intensity of the P-polarized component or the intensity of the S-polarized component for the first light beam in the light reception unit starts based on the result of picture recognition of an output signal from the imaging element.
(11)

The imaging apparatus according to (10), wherein

acquisition of the intensity of the P-polarized component or the intensity of the S-polarized component for the first light beam in the light reception unit is performed in a certain period.
(12)

A light amount measurement apparatus comprising:

a light beam division element for dividing an incident light beam into a first light beam and a second light beam;

a light reception unit on which one of the first light beam or the second light beam is incident, for acquiring an intensity of a P-polarized component or an intensity of an S-polarized component for the one light beam; and

a signal processing unit for outputting a predicted calculation value of an intensity of a P-polarized component or a predicted calculation value of an intensity of an S-polarized component for the other of the first light beam and the second light beam, from the intensity of the P-polarized component or the intensity of the S-polarized component acquired by the light reception unit.
(13)

A computer-readable recording medium having a program recorded thereon, the program causing a computer to execute:

receiving an intensity of a P-polarized component or an intensity of an S-polarized component for a part of one incident light beam divided from the one incident light beam by a light beam division element, and outputting a predicted calculation value of an intensity of a P-polarized component or a predicted calculation value of an intensity of a S-polarized component for a residual light beam of the one incident light beam, from data of reflectance or transmittance of the light beam division element corresponding to the P-polarized component or the S-polarized component.
(14)

A method of calculating an exposure amount, the method comprising:

acquiring, by a first light reception unit, an intensity of a P-polarized component or an intensity of an S-polarized component for a first light beam divided from one incident light beam by a light beam division element; and

predicting, by a signal processing unit, an intensity of a P-polarized component or an intensity of an S-polarized component for a second light beam divided from the one incident light beam by the light beam division element, from the intensity of the P-polarized component or the intensity of the S-polarized component acquired by the first light reception unit, to calculate an exposure amount in a second light reception unit on which the second light beam is incident.

The present disclosure contains subject matter related to that disclosed in Japanese Priority Patent Application JP 2011-121869 filed in the Japan Patent Office on May 31, 2011, the entire content of which is hereby incorporated by reference.

What is claimed is:

1. An imaging apparatus comprising:
a light beam division element for dividing an incident light beam into a first light beam and a second light beam;
a light reception unit on which the first light beam is incident, for acquiring an intensity of a P-polarized component or an intensity of an S-polarized component for the first light beam;
an irradiated body on which the second light beam is incident;
a signal processing unit for outputting a predicted calculation value of an intensity of a P-polarized component or a predicted calculation value of an intensity of an S-polarized component for the second light beam, from the intensity of the P-polarized component or the intensity of the S-polarized component acquired by the light reception unit;
a shutter for switching incidence and blocking of the second light beam on and to the irradiated body; and
an iris for adjusting an amount of the second light beam reaching the irradiated body,
wherein at least one of a shutter speed of the shutter or an opening of the iris is adjusted according to an output from the signal processing unit.

2. The imaging apparatus according to claim 1, further comprising:
a storage unit for storing a ratio of transmittance of the light beam division element for the P-polarized component and reflectance of the light beam division element for the P-polarized component and a ratio of transmittance of the light beam division element for the S-polarized component and reflectance of the light beam division element for the S-polarized component.

3. The imaging apparatus according to claim 1, wherein
an angle between a normal to a reflection surface of the light beam division element and an optical axis of the incident light beam is constant.

4. The imaging apparatus according to claim 1, wherein
the light beam division element is evacuated from the incident light beam when the second light beam is incident on the irradiated body.

5. The imaging apparatus according to claim 1, wherein
the light reception unit includes a polarization element and a light receiving element.

6. The imaging apparatus according to claim 5, wherein
the polarization element includes a liquid crystal element.

7. The imaging apparatus according to claim 1, wherein
the signal processing unit outputs the predicted calculation value for each divided wavelength band.

8. The imaging apparatus according to claim 1, wherein
acquisition of the intensity of the P-polarized component or the intensity of the S-polarized component for the first light beam in the light reception unit is continuously performed when the first light beam is incident on the light reception unit.

9. The imaging apparatus according to claim 1, wherein
the irradiated body is an imaging element.

10. The imaging apparatus according to claim 9, wherein
acquisition of the intensity of the P-polarized component or the intensity of the S-polarized component for the first light beam in the light reception unit starts based on the result of picture recognition of an output signal from the imaging element.

11. The imaging apparatus according to claim 9, wherein
acquisition of the intensity of the P-polarized component or the intensity of the S-polarized component for the first light beam in the light reception unit is performed in a certain period.

12. A light amount measurement apparatus comprising:
a light beam division element for dividing an incident light beam into a first light beam and a second light beam;
a light reception unit on which one of the first light beam or the second light beam is incident, for acquiring an intensity of a P-polarized component or an intensity of an S-polarized component for the one light beam; and
a signal processing unit for outputting a predicted calculation value of an intensity of a P-polarized component or a predicted calculation value of an intensity of an S-polarized component for the other of the first light beam and the second light beam, from the intensity of the P-polarized component or the intensity of the S-polarized component acquired by the light reception unit.

13. A computer-readable recording medium having a program recorded thereon, the program causing a computer to execute:
receiving an intensity of a P-polarized component or an intensity of an S-polarized component for a part of one incident light beam divided from the one incident light beam by a light beam division element, and outputting a predicted calculation value of an intensity of a P-polarized component or a predicted calculation value of an intensity of a S-polarized component for a residual light beam of the one incident light beam, from data of reflectance or transmittance of the light beam division element corresponding to the P-polarized component or the S-polarized component.

14. A method of calculating an exposure amount, the method comprising:
acquiring, by a first light reception unit, an intensity of a P-polarized component or an intensity of an S-polarized component for a first light beam divided from one incident light beam by a light beam division element; and
predicting, by a signal processing unit, an intensity of a P-polarized component or an intensity of an S-polarized component for a second light beam divided from the one incident light beam by the light beam division element, from the intensity of the P-polarized component or the intensity of the S-polarized component acquired by the first light reception unit, to calculate an exposure amount in a second light reception unit on which the second light beam is incident.
